(19) United States
(12) Patent Application Publication
(10) Pub. No.: US 2016/0251245 A1
(43) Pub. Date: Sep. 1, 2016

(54) BIOFILTRATION SYSTEM AND PROCESS FOR COMBINED AND SIMULTANEOUS TREATMENT OF METHANE AND OF LEACHATE

(71) Applicant: CENTRE DE RECHERCHE INDUSTRIELLE DU QUEBEC, Quebec (CA)

(72) Inventors: Nicolas TURGEON, Quebec (CA); Rino DUBE, Quebec (CA); Gerardo BUELNA, Quebec (CA); Yann LE BIHAN, Quebec (CA)

(73) Assignee: CENTRE DE RECHERCHE INDUSTRIELLE DU QUEBEC, Quebec (CA)

(21) Appl. No.: 15/031,085

(22) PCT Filed: Oct. 23, 2014
(86) PCT No.: PCT/CA2014/051028

§ 371 Date: Apr. 21, 2016

Related U.S. Application Data
(60) Provisional application No. 61/894,668, filed on Oct. 23, 2013.

(51) Int. Cl. C02F 3/04; C02F 3/10; B01D 53/85; C02F 3/30

(52) U.S. Cl. CPC C02F 3/04; C02F 3/303; C02F 3/106; B01D 53/85; C02F 2101/16

(57) ABSTRACT

The present invention relates to a system and process for combined and simultaneous treatment of methane and of nitrogenous liquid effluent, inter alia, landfill leachates. Principally, the invention provides a biofiltration system and process for the combined and simultaneous treatment of gas containing methane (CH₄) and of nitrogenous liquid effluents by virtue of synergy between nitrifying and methanotrophic microorganisms. The use of a single biofiltration system according to the invention avoids recourse to two treatment lines specific to methane and to the effluent. Furthermore, the exothermic reaction for biological oxidation of methane enables temperature regulation of the biofilter even during winter periods.

### CONTEXT OF THE INVENTION

The environmental management of landfill sites represents a serious environmental challenge. Indeed, these sites are a major source of contaminants and require strict environmental monitoring as regards two main problems.

Firstly, landfill waste is responsible for about 5% of Greenhouse Gas (GHG) in Quebec (Canada) with 4.1 Mt CO₂eq in 2010. Specifically, landfill sites represent a major source of methane (CH₄), a compound recognized by the Kyoto Protocol as being one of the six main GHGs. Its Global Warming Potential (GWP) is around 21 to 25 times higher than that of carbon dioxide (CO₂). In some cases, methane (biogas) can be recovered or burned with the aid of flares when concentrations exceed 25%. But for lower concentrations, a make-up gas (propane, natural gas) must be added to enable its combustion. This approach is very costly, however, and runs counter to the aims of reducing GHG.

Subsequently, landfill sites generate leachates, namely water from precipitation that becomes heavily contaminated after percolating through layers of buried waste. This constitutes a potential source of groundwater contamination and requires special treatment before it can be discharged into the natural environment.

### SUMMARY OF THE INVENTION

The main aim of the invention is to propose a biofiltration system and process for the combined and simultaneous treatment of methane (CH₄) and leachate from sources such as landfill sites. Using one biofiltration system according to the invention avoids the need for two treatment chains specific to methane and leachate, reducing installation costs and simplifying the system's design. An embodiment of the system and process according to the invention aims to convert the CH₄ contained in the landfill gas (LFG) to a concentration below around 20%, 12%, 5% or 3%, or between 0.5% and 1%, at conversion efficiency levels above around 50% or 0%.

Another embodiment of the system and process according to the invention relates to the treatment of leachates from landfill sites enabling one or more of the following purification performance levels to be achieved: BOD₅<65 mg/l, Suspended Solids (SS)<35 mg/l, NH₄<10 mg/L, fecal coliforms <100 CFU/100 ml, and pH between 6 and 9.5, with minimal by-products from the transformation of nitrogen in the form of nitrates at output.

Another embodiment of the system and process according to the invention is aimed at treating a leachate at a surface flow rate of up to 200 L/m².d, or at an applicable load limit of 0.2 kgBODs/m².d, 0.05 kg/SS/m².d or 0.055 kgN/m².d.

According to an embodiment of the system and process according to the invention, the microorganisms (e.g. heterotrophs, nitrificants, methanotrophs) participating in the combined treatment of the CH₄ contained in landfill gases (LFG) and leachates from a landfill site cohabit on the basis of a profile within one and the same percolating biofiltration medium.

According to an embodiment of the system and process according to the invention, the nitrates (NO₃) from the transformation of the NH₄ in the leachate serve as nutrients for the methanotrophic microorganisms, a synergy that helps to reduce the nitrates in the leachates.

According to an embodiment of the system and process according to the invention, the transformation of NH₄ nitrogen can be stabilized on an annual basis by recycling the exothermic process associated with the biological oxidation of NH₄, enabling nitrification to continue during the winter.

Implementation of one of the embodiments of the system and process according to the invention has enabled the impact of the leachate load on the rates of conversion of CH₄ to be determined.

### DETAILED DESCRIPTION OF THE EMBODIMENTS OF THE INVENTION

The treatment system according to an embodiment of the invention uses a slow-percolation biofilter on a fixed-culture organic carrier. The passage of gaseous and liquid effluents therefore occurs through the filtering medium acting as a purification medium, which may consist of readily available natural elements, such as peat and woodchips with added calcite, on which the biomass responsible for the treatment of contaminated effluents develops.

Various purification mechanisms operate in the filtering medium, thus enabling treatment of the effluents. On the one hand, the physical-chemical mechanisms allow the pollutants to be retained either by filtration, adsorption or absorption. On the other hand, biological mechanisms using specific microorganisms act on the pollutants and cause them to biodegrade. The efficiency of the biofilters lies in maintaining an active biomass that is sufficiently large to ensure a satisfactory level of treatment.

As regards the nutritional needs of the biomass, in order to ensure optimum development of microorganisms known as methanotrophs, i.e. capable of converting CH₄ into CO₂, nitrogenous nutrients in the form of nitrates (NO₃) must be available and for that reason an intake of nitrogen must be introduced into the process. The aim is for the nitrifying microorganisms present in the leachate to be treated to colonize the filtering medium sufficiently to generate a quantity of NO₃ enabling the biofilter to be self-sufficient in nitrogenous nutrients. For this reason, the inoculum used to introduce methanotrophic microorganisms on start-up may contain manure treated by biofiltration, rich in nitrifying microorganisms.

The most favorable temperatures for the bioconversion of methane are between 25 and 35° C. Given that the methane degradation reaction releases heat (exothermic reaction), it is possible to assess the intensity of bacterial activity indirectly by measuring the temperature in the biofilter.

For optimum bioconversion of methane, the pH of the medium must ideally be close to neutral. In fact, methanotrophic microorganisms develop well in a medium where the pH is between 5.5 and 8.5.

As regards the introduction of methanotrophic microorganisms, it is advantageous to inoculate the filtering medium in order to reduce the start-up time for treatment of CH₄. In fact, using an inoculum enables the specific introduction of methanotrophic microorganisms capable of treating CH₄ and thus, of quickly starting its bioconversion. For example, an appropriate inoculum can be obtained by collecting some purified output liquid from a biofiltration system operating to treat a liquid effluent in the presence of CH₄, such as pig's manure or other similar organic material, said output liquid being likely to contain methanotrophic microorganisms. The liquid collected can be used directly as an inoculum or undergo a procedure aimed at activating the proliferation of methanotrophic microorganisms prior to inoculation.

As regards the intake of microorganisms required to treat the leachate, the development of the biomass for this purpose can usually be assured without an external intake since the leachate is rich in microorganisms that are acclimatized. Thus, no inoculation is usually required to start the treatment of the leachate since the bacterial flora already present in the leachate can develop by itself within the filtering medium. There will then be a consortium of microorganisms capable of degrading the various compounds present in the leachate to be treated.

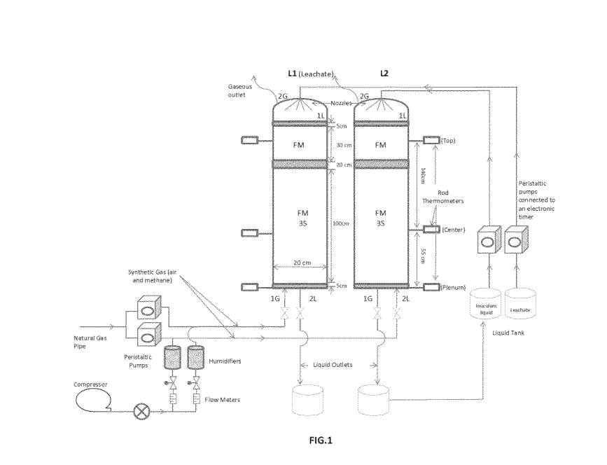

FIG. 1 shows an embodiment of a system including a biofiltration column L1 fed so as to perform a combined treatment of methane and leachate. A column L2 fed so as to treat methane and leachate separately enabled a comparison to be made between the performance of combined treatment relative to separate treatment. In the example shown, the biofiltration columns used, L1 and L2, are made of PVC, are 20 cm in diameter and contain a layer of filtering medium 1.6 m high. Columns L1 and L2 are connected to a synthetic gas feed source consisting of a mixture of methane and air, and a leachate feed device. During operation, column L1 enables an upward diffusion of methane parallel to a percolation of leachate, both occurring simultaneously. The leachate is injected at the top of columns L1 and L2 whereas the synthetic gas is introduced into the columns at the bottom. In the example shown, a synthetic gas simulating the gaseous effluent containing methane is created by mixing methane and air, the methane coming from a natural gas supply pipe whose flow rate is regulated by a mass flow meter, model MC-50SCCM-D supplied by Alicat Scientific (Tucson, Ariz.) connected to each of the supply pipes of columns L1 and L2. The airflow for mixing comes from an air compressor controlled by a pressure regulator and a flow meter for each of the supply pipes to the columns. The air then passes into a conditioning system in order to be humidified before rejoining the methane in each supply pipe providing the mixture that forms the gaseous effluent containing the methane to be treated, having a typical concentration of 1% (10,000 ppm or 6,544 mg/m³) for the purpose of the test performed as described later on. In order to pass upwards through the filtering medium, the gaseous effluent containing the methane is introduced through an inlet located beneath each of the columns L1 and L2. The leachate is distributed uniformly over the surface of the filtering medium of columns L1 and L2 by nozzles fitted at the top of the columns, then passes through the respective filtering media by percolation. The nozzles can be fed with inoculum liquid and leachate by peristaltic pumps, Easyload II Model, No 77200-52, produced by Masterflex™ and supplied by Cole-Parmer (Vernon Hills, Ill.), whose operating sequences can be programmed by an electronic timer. For the purpose of the test performed as described below, a leachate from a Technical Landfill Site (TLS) taken at the outlet of holding lagoons (before treatment), was used.

In the example of the system shown, each column uses an identical filtering medium composed of five layers, namely, from the bottom up: 5 cm of woodchips, 100 cm of an organic mixture (peat and woodchips) including a carbonate source (crushed oyster shells or calcite), 20 cm of woodchips (serving as a possible gas outlet in the event of overpressure), 30 cm of an organic mixture and 5 cm of woodchips. More precisely, the composition of the filtering medium can contain a mixture of peat (20% v/v), woodchips (80% v/v) and an additional volume of crushed oyster shells (15% v/v of the total mixture of woodchips and peat). The addition of crushed oyster shells in the filtering medium enables heavy metals that the leachate may contain to be captured. Moreover, the shells act as a buffer allowing the pH to be stabilized in the event of acidification of the liquids, caused by the nitrification process. The key design data of the biofiltration columns described above with regard to the example shown in FIG. 1 are given in Table 1.

TABLE 1
Design parameters of the biofiltration columns

| | |
|---|---|
| Lining of the filtering | Peat (80% v/v) |
| medium | Woodchips (20% v/v) |
| | Crushed oyster shells |
| | 20% of the peat/woodchip volume |
| | 1 mm < particle size < 3.35 mm |
| Height of the lining | 5 cm of woodchips |
| | 100 cm of organic filtering medium |
| | 20 cm of woodchips (W) |
| | 30 cm of organic filtering medium (FM) |
| | 5 cm of woodchips |
| Total height of the | 1.60 m (the layers of woodchips are |
| filtering medium | regarded as the absorbing part of the |
| | filtering medium) |
| Internal diameter | 20 cm |
| Internal section | 0.031 m² |
| Volume of filtering medium | 50.3 L |

The following section presents the methodology and results obtained from a first test period of combined treatment of methane and leachate taking place over approximately 70 days and using the system described above with reference to FIG. 1.

This first test period involved performing, inside one biofilter, a simultaneous biological treatment of a TLS leachate and a gas containing 1% v/v of methane. The circulation of the elements to be treated involved an upward gaseous flow, circulating in the opposite direction to a percolating flow of a leachate to be treated. Since this was a biological treatment, it was necessary to introduce the microorganisms essential for the treatment of the above-mentioned effluents. As a first step, during the start-up phase, the methanotrophic microorganisms capable of treating the methane were introduced by inoculation. To achieve this, an inoculation liquid, rich in methanotrophic microorganisms, was continually recirculated through the biofilters until a steady EE of at least 80% was reached. Achieving this level of efficiency in fact suggested that a methanotrophic biomass capable of efficiently converting methane into carbonic gas was established in the filtering medium of the biofilters. The inoculation of methanotrophic microorganisms considerably reduces the start-up time of the process by biofiltration. In fact, inoculation enables a biomass to be obtained that is capable of starting the treatment of methane after only 10 to 20 days rather than several weeks or even months. Using an inoculum liquid from the liquid outlet of a biofilter treating gaseous effluents containing methane is a simple and efficient way to achieve this. As a second step, during the combined treatment phase, the biomass capable of treating the leachate was established. To do this, leachate was fed in over several days to enable the development of microorganisms capable of reacting with the various compounds present in the leachate so as to biodegrade them. The aim was therefore to obtain a consortium of microorganisms capable of treating the methane and leachate circulating in the test columns at the same time. In other words, the aim of the test was to check that the two treatment processes were capable of coexisting in the same biofilter, more particularly that the methanotrophic microorganisms were able to tolerate the presence of the toxic elements present in the TLS leachates and the leachates were able to provide the nutrients required by the methane bioconversion mechanisms.

This first test period of combined treatment was performed in biofiltration column L1 while biofiltration column L2 acted as a control. During the test, the operating conditions were identical for both columns. This means that the liquid and gaseous flow rates as well as their methane content in the synthetic gas were the same for L1 and L2. The distinction between the two columns focused on the nature of the liquids used and their mode of circulation. Thus, during the combined treatment phase, L1 received, without recirculation, TLS leachate while L2 received, with recirculation, inoculation liquid containing nitrogenous nutrients (nitrates). These differences allowed a distinction to be drawn between the hydraulic effects of the flows and the physico-chemical effects caused by the different nature of the liquids used. Moreover, using a control in these conditions ensured that an inoculation liquid rich in methanotrophic microorganisms, possibly required for the inoculation of new columns, was readily available. Moreover, it should be noted that, for the entire duration of the first test period, no nitrogenous nutrients were added to the leachate to be treated, received by L1.

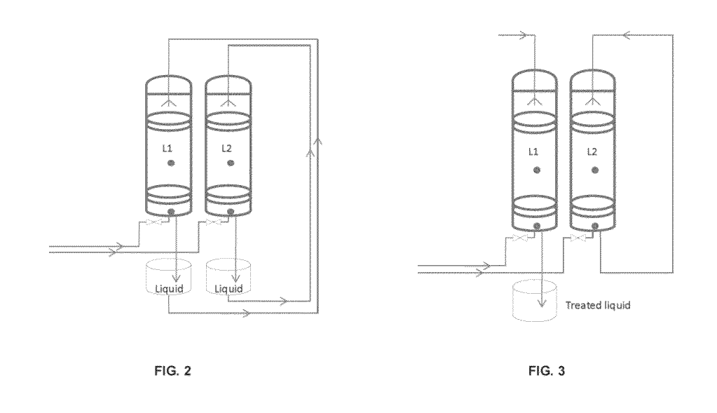

A first start-up phase was performed, having as its aim the inoculation of the filtering medium by the methanotrophic microorganisms. To do this, the two columns L1 and L2 were inoculated with an inoculation liquid of which half comprised an inoculation liquid rich in methanotrophic microorganisms from an operating biofiltration system, as explained above. This inoculation liquid was recirculated in the columns throughout the start-up period in order to promote the development of biomass in the filtering medium. Also, in order to inoculate the filtering medium of nitrifying microorganisms, half of the recirculated liquid contained effluent from a biofilter having treated pig's manure rich in nitrifying microorganisms. The aim of using this mixture is the simultaneous inoculation of methanotrophic microorganisms for the treatment of methane and of nitrifying microorganisms for the nitrate requirements of the methanotrophs, thus reducing the time required to establish the biomass needed for treatment. Using an inoculum in the form of inoculation liquid during the start-up of a methane biofiltration process, in recirculation mode, enables a steady state to be reached more quickly, that is, in only about ten days. The effective operating parameters during the start-up phase of the first test period are set out in Table 2, the start-up configuration being represented schematically in FIG. 2.

TABLE 2

| | Values | |
|---|---|---|
| Operating Parameters | L1 | L2 - Control |

Gaseous Part

| Concentration of methane at | 10,000 ppm | | 10,000 ppm | |
|---|---|---|---|---|
| input in the synthetic gas | (1% v/v) | | (1% v/v) | |
| Synthetic gas flow | 1 | L/min | 1 | L/min |
| Superficial velocity | 2.0 | m/h | 2.0 | m/h |

Liquid Part

| Nature of the liquid | Inoculum liquid | | Inoculum liquid | |
|---|---|---|---|---|
| | and biofilter | | and biofilter | |
| | effluent | | effluent | |
| | treating pig's | | treating pig's | |
| | manure | | manure | |
| Flow rate of leachate in | 1.14 | L/d | 1.14 | L/d |
| recirculation | | | | |
| Injection sequence | 95 | ml/2 h | 95 | ml/2 h |
| KNO₃ concentration | 2000 | mg N/L | 2000 | mg N/L |
| (equivalent in nitrates) | | | | |

After completing the first start-up phase, when the methanotrophic microorganisms were sufficiently active to perform a stable and effective treatment of the methane in terms of elimination efficiency (EE ≧80% for L1 and the control L2), a second phase involving combined treatment was begun, by changing the nature of the inoculation liquid of column L1, which was replaced by TLS leachate without recirculation. Moreover, from that moment, there was no more external intake of inoculum and liquid from a biofilter treating pig's manure for the liquid in control column L2. The effective operating parameters during the combined treatment phase of the first test period are shown in Table 3, the configuration of combined treatment being schematically shown in FIG. 3. The flow rate was the only operating parameter being changed during the test, the other operating conditions having remained unchanged.

TABLE 3

| | Values | |
|---|---|---|
| Operating Parameters | L1 | L2 - Control |

Gaseous Part

| Concentration of methane at | 10,000 ppm | | 10,000 ppm | |
|---|---|---|---|---|
| input in the synthetic gas | (1% v/v) | | (1% v/v) | |
| Synthetic gas flow | 1 | L/min | 1 | L/min |
| Superficial velocity | 2.0 | m/h | 2.0 | m/h |

Liquid Part

| Nature of the liquid | TLS leachate | | Inoculation liquid | |
|---|---|---|---|---|
| Liquid flow rate | 1.14 L/d | | 1.14 L/d | |
| | for 15 days | | for 15 days | |
| | 2.4 L/d | | 2.4 L/d | |
| | for 25 days | | for 25 days | |
| Circulation mode | Non-recirculated | | Recirculated | |
| Injection sequence | 95 | ml/2 h | 95 | ml/2 h |

| | | | |
|---|---|---|---|
| N_NO₃ target concentration | No addition of | 2000 | mg N/L |
| (by adding KNO₃) | KNO₃ | | |

Various analysis parameters were constantly monitored throughout the first test period. Tables 4A and 4B show the nature of the analytical parameters considered as well as their respective frequency of monitoring. The temperature measurement positions correspond to those of the thermometers shown in FIG. 1.

TABLE 4A

| Sample | | | Sampling | |
|---|---|---|---|---|
| Type | Parameters | Frequency | Points | Method |
| Gas | CH₄ | 3 times/week | 1G-2G | FTIR (Gasmet) |
| | CO₂ | 3 times/week | 1G-2G | FTIR (Gasmet) |
| | N₂O | 3 times/week | 1G-2G | FTIR (Gasmet) |
| | Flow rate | 3 times/week | 1G-2G | Rotameter |
| | | once/2 weeks | | Bubble |
| | | | | flowmeter |
| | Temperature | Punctual | 1G | Thermometer |
| | | (3 times/ | | |
| | | week) | | |
| | Pressure | once/week | 1G | Pressure |
| | (loss) | | | gauge |
| Filtering | Temperature | Punctual | 3S | Thermometer |
| medium | | (3 times/ | At the | |
| | | week) | bottom | |
| | | | (plenum), | |
| | | | at mid- | |
| | | | height and | |
| | | | at the top | |
| | Measurement | Every week | 3S | |
| | of the lining | | | |
| | height in | | | |
| | order to | | | |
| | measure the | | | |
| | compaction | | | |
| | of the | | | |
| | filtering | | | |
| | medium | | | |

TABLE 4B

| | | Frequency | | | |
|---|---|---|---|---|---|
| Sample | | In-house | Lab | Sampling | |
| Type | Parameters | Analysis | Analysis | Points | Method |
| Liquid | N_NO₂—NO₃ | twice/week | once/month | 1L-2L | MA 4073M |
| | TKN | | once/month | 1L-2L | MA 4048M & |
| | | | | | MA 4049M |
| | Phosphorus | | once/month | 1L-2L | MA 4054M |
| | Potassium | | once/month | 1L-2L | MA 4054M |
| | pH | 3 times/ | once/ | 1L-2L | pH-meter |
| | | week | 14 days | | |
| | BOD₅ | | once/ | 1L-2L | SM 5210 B |
| | | | 14 days | | |
| | COD | once/week | | 1L-2L | Hach 8000 |
| | SM | | once/ | 1L-2L | MA-4052M |
| | | | 14 days | | |
| | N_NH₄ | once/week | once/month | 1L-2L | Hach 10031 |
| | Metals (Zn) | | once/month | 1L-2L | MA200-Met |
| | | | | | 1.1 R3 |
| | Flow rate | once/week | | 1L-2L | Graduated |
| | | | | | cylinder |
| | Cleaning the | once/week | | 1L | Dismantling & |
| | feed nozzles | | | | rinsing |

Note that for control column L2, considering the recirculation of the inoculation liquid, the concentrations at inlet must be the same as those at outlet (except for potassium because KNO₃ is added). Consequently, the verifying analyses in the laboratory only related to the liquid at the outlet of control column L2.

As mentioned above, the leachate to be treated was taken from a TLS, the sampling point having been chosen upstream of a treatment system in order to obtain raw untreated leachate. The leachate taken from the TLS was stored at a temperature of 4° C. in a 200-liter tank, and each time the liquid tank of column L1 was refilled, the leachate contained in the tank was mixed in order to homogenize it, so as to provide an unsettled leachate representative of the leachate taken from the TLS.

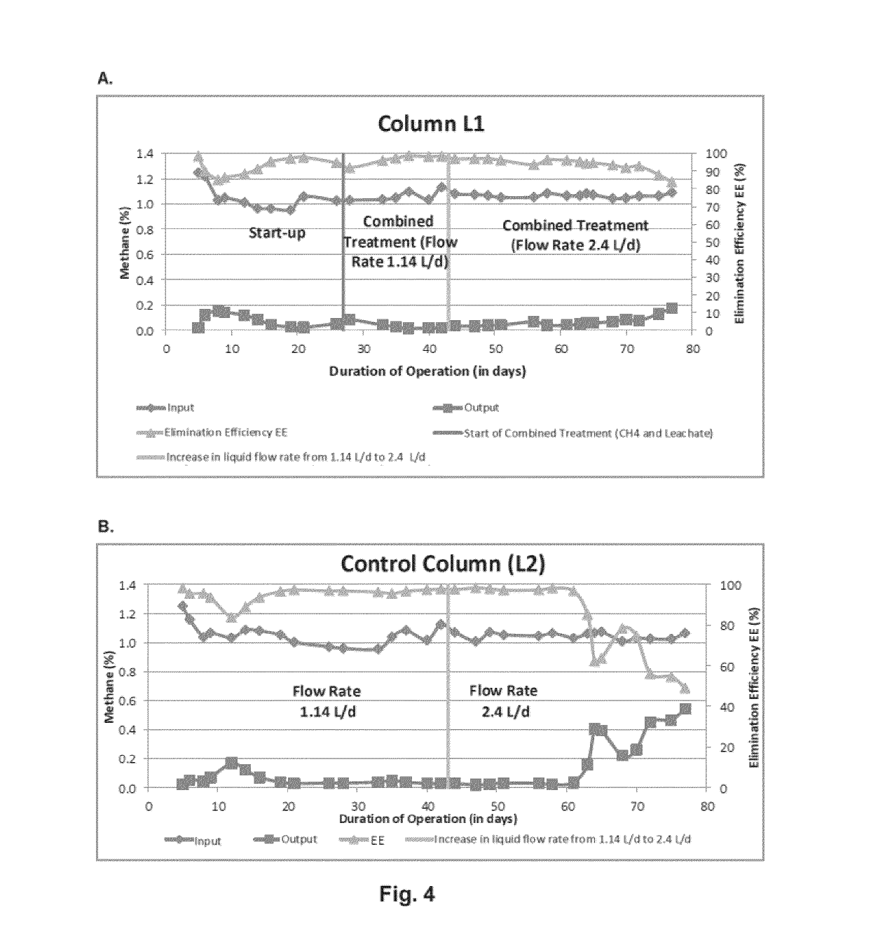

The elimination efficiency (EE) parameter was used during the first test period to measure the performance of the methane treatment process. By constantly monitoring the evolution of this parameter, it was possible to check the level of activity of the methanotrophic biomass. The graphs in FIG. 4 show, for columns L1 and L2 respectively, the evolution of the methane concentration at the inlet and outlet of the columns as well as the EE parameter as a function of the duration of operation. From the very first measurements (5th day of operation), the columns already had EE values of at least 96%, clearly indicating that the inoculation of the filtering media enabled the desired methanotrophic microorganisms to be in place very quickly and efficiently. Note that the lowest EE value during the start-up period was in the order of 85%, representing a value above the objective. After the 26th day of operation, the columns reached a treatment stability and performance level deemed sufficient to move into the next phase of the test, namely that involving the introduction of the leachate to be treated in column L1. The corresponding graph in FIG. 4 shows that the replacement of the inoculation liquid by the leachate in L1 had no negative effect on the EE level of this column. Against all expectations, the EE seems even to have slightly increased with the introduction of the leachate. The biomass of methanotrophs in L1 therefore withstood the presence of this liquid very well. After the increase in liquid flow rates, the EE values of L1 remained at high levels in the order of 95%. The methanotrophic microorganisms in column L1 withstood very well the increased contact with the leachate to be treated. Nevertheless, a downward trend of the EE values can be seen after the increase in flow rate. It may be, therefore, that the flow rate of 2.4 L/d represents a top limit for combined treatment, this higher flow rate possibly having created more water-saturated anaerobic zones, causing a reduction in the diffusion of molecular oxygen towards the biomass of methanotrophs.

It should be noted from the graph in FIG. 4 that the control column L2 performed well during the high flow rate phase. In fact, the increase in flow rate did not affect the EE values, which remained around 95% for about 15 days. As regards the EE results for the final days of operation (64th day to 70th day) of the control L2, a large drop in EE values was observed. This could be attributed to the accumulation of byproducts from the bioconversion of methane in the inoculation liquid by continuous recirculation of the output liquid of control L2. These byproducts could have harmful effects for the biomass when a certain concentration threshold is reached. Furthermore, the drop in EE values of the control L2 could be attributable to the accumulation of potassium caused by the frequent addition of KNO₃, resulting in the accumulation of potassium in the recirculation liquid up to concentrations that could be considerable and therefore harmful to the microorganisms present in the filtering media of column L2. Laboratory analyses whose results are set out in Table 5 showed that the potassium concentration in the liquid of control column L2 reached high levels, in the order of 6,900 ppm, unlike column L1 for which a lower level in the order of 4,000 ppm was recorded. Lastly, a lack of trace elements such as phosphorus or even too high a hydraulic load may also have contributed to the drop in EE values for control column L2.

TABLE 5

| | | L1 | | | L2 | | |
|---|---|---|---|---|---|---|---|
| Parameter | Day | Input | Output | Variation | Input | Output | Variation |
| BOD₅ | 49 | 548 | 135 | −75% | — | — | — |
| (mg O₂/L) | 65 | 107 | 33 | −70% | — | — | — |
| ₚH | 49 | 7.82 | 9.14 | — | — | — | — |
| | 65 | 8.38 | 8.87 | — | — | — | — |
| NKT | 44 | 587 | 39 | −93% | — | 49.9 | — |
| (mg/L) | | | | | | | |
| N_NH₃ | Average | 507 | 11 | −98% | 4 | 4 | 0% |
| (mg/L) | during | | | | | | |
| | the test | | | | | | |
| N_NO₃ | 44 | 1 | 643.8 | — | — | 1551.4 | — |
| (mg/L) | | | | | | | |
| N_NO₂ | 44 | 1.1 | 10.9 | — | — | 24.7 | — |
| (mg/L) | | | | | | | |
| SM | 43 | 50 | 13 | −74% | — | 27 | — |
| (mg/L) | 65 | 177 | 70 | −60% | — | — | — |
| Phosphorus | 44 | 4.47 | 0.78 | −83% | — | 1.10 | — |
| (mg/kg) | | | | | | | |
| Potassium | 44 | 832 | 4073 | +390% | — | 6909 | — |
| (mg/kg) | | | | | | | |
| Zinc | 44 | 0.2 | 0.68 | +240% | — | 0.96 | — |
| (mg/L) | 65 | 0.09 | 0.23 | | | | |

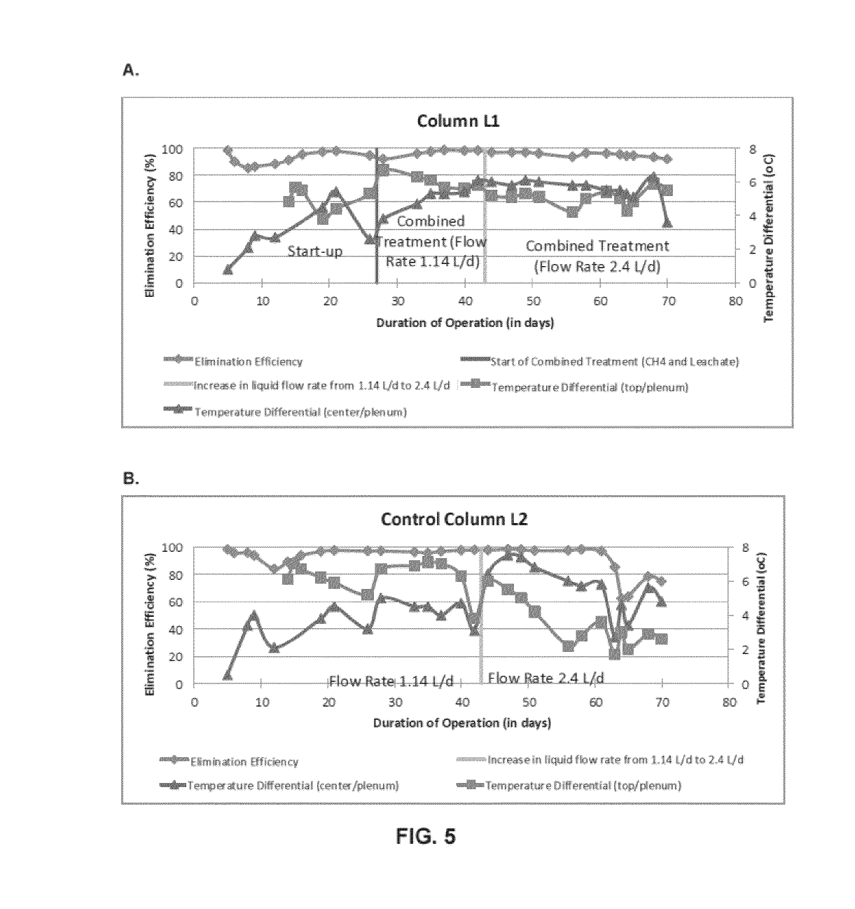

As the bioconversion of methane by methanotrophs is an exothermic reaction, it was possible to follow the methane treatment activity by measuring the temperatures inside columns L1 and L2. As shown in FIG. 1, three thermometers were installed on each of these columns: the first located at the bottom of the columns—“plenum” thermometer —, the second between the bottom and the layer of woodchip—“center” thermometer —, and the third at the top of the columns—“top” thermometer. The graphs in FIG. 5 show, for columns L1 and L2 respectively, the evolution of the respective temperature differentials between the “center” and “top” thermometers on the one hand and the “plenum” thermometer on the other.

The graphs in FIG. 5 show that during the start-up period, the temperature differentials were higher for the “top” thermometers in both columns L1 and L2 than for the “center” thermometers. This observation suggests that methanotrophic activity was more intense at the top of the columns. This could be explained by a greater availability of nitrogenous nutrients at the top of the columns compared to the bottom. The injection of leachate into L1 caused a drop in the differential for the “top” thermometer and a rise for that of the “center” thermometer in the days following this injection. This observation suggests that the introduction of leachate had the effect of encouraging the methanotrophs to move downwards, thus moving away from the liquid inlet. The intake of leachate unbalanced the conditions at the top of L1, making them less conducive to the development of methanotrophs, which confirms the comparison with the temperature differentials of control column L2 for which the temperature differentials remained systematically higher for the “top” thermometer than for the “center” thermometer. After the increase in flow rate, it is noted that the temperature differentials for L1 continued their movement triggered by the introduction of leachate. The “center” thermometer became the one that had the highest differential, whereas the “top” one cooled slightly following this change in flow rate. The increase in flow rate appears to have had the effect of supporting the tendency, triggered by the introduction of leachate, for the methanotrophic biomass to move towards the bottom of L1. The effect of the increase in flow rate also caused the methanotrophs to move within the control column. In fact, the temperature differentials for the “top” and “center” thermometer swap their importance as a result of the increase in flow rate; the “center” thermometer having become hotter than the “top” one from that moment. The hydraulic effect on the methanotrophs would not therefore be insignificant. Note that for the control column L2, the two temperature differentials followed a downward trend after reaching higher levels between the 45th and 50th day indicating a gradual slow-down in methanotrophic activity.

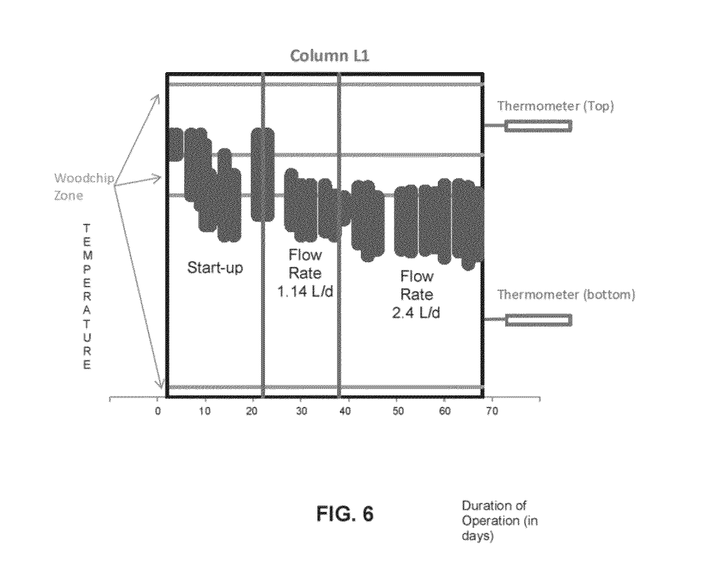

By using an infrared thermometer, it was possible to follow the evolution of the temperature along the walls of column L1 and control column L2. This enabled the hottest zone to be located and so the most active treatment zone to be identified. The use of said thermometer therefore enabled temperature readings to be obtained along the entire length of the columns and not be limited merely to the three reading points offered by the rod thermometers. The graph in FIG. 6 shows the most active (hottest) treatment zones in the columns as a function of the duration of operation, covering a temperature measurement period spread over about 70 days. Said zones where the temperature of the wall was highest are shown by a dark line. The upper and lower limits of these hot zones were defined by reaching a difference of 0.5° C. compared to the highest temperature measured on the column walls. The graph in FIG. 6 suggests that during the start-up period, the most active zone for the treatment of methane was where the intermediate layer of woodchips was located. This zone of woodchips, characterized by a near absence of peat and considerable macroporosity, has no equivalent elsewhere in the column linings. There was therefore a singular zone that offered favorable conditions for the development of methanotrophs. The possible movement of the methanotrophs was substantiated by the measurements of the infrared thermometer. Indeed, the graph in FIG. 6 shows that, for column L1, the injection of leachate caused the hot zone to move downwards and that this movement persisted and was even slightly accentuated when the flow rate increased.

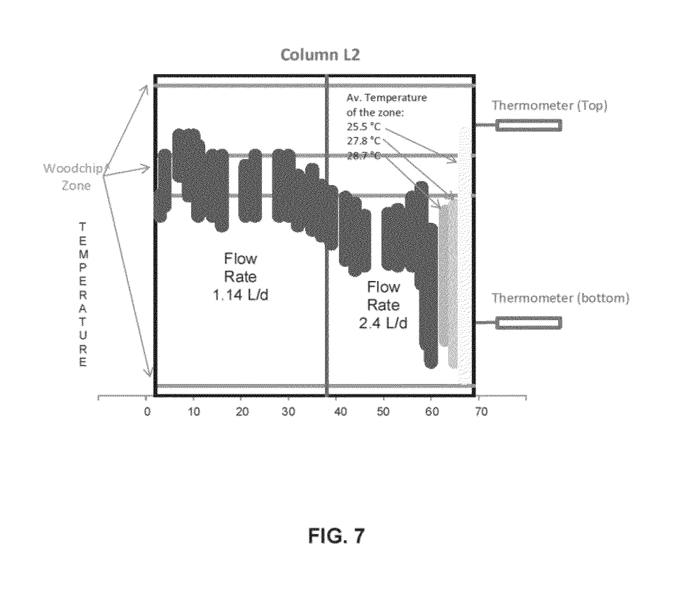

The graph in FIG. 7 shows that for the control column L2, the increase in flow rate had the same effect on the hot zone, namely, to cause a downward movement. Hydrodynamic conditions would therefore have a significant effect on the position of the methanotrophs in the filtering medium. It was observed that during the drop in EE values for control column L2 as day 70 approached, the production of heat fell and the hot zone, dropping from 28.7 to 25.5° C., was wider.

The following section sets out the results obtained concerning the analytical monitoring parameters considered during the first test period, relating to the liquid phase of columns L1 and L2.

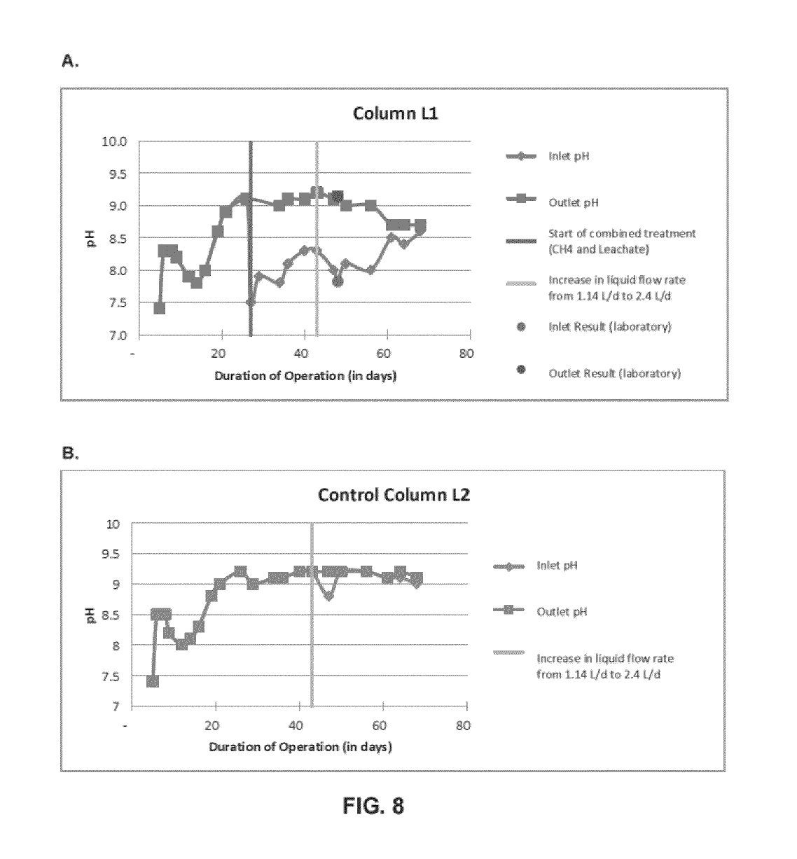

As regards the pH, the graph at the top of FIG. 8 clearly shows that column L1 had the effect of increasing the pH of the liquid treated. In fact, the pH of the leachate increased on average from 8 units to 9 units after passing through L1, whereas it would have been expected that nitrification phenomena would have instead caused acidification of the liquid. With respect to the graph at the bottom of FIG. 8, the control column L2 also systematically generated rather high pH values at output, in the order of 9 units, the virtually identical input and output pH values being explained simply by the fact that the liquid was constantly recirculating during the test. Given the high EE values of the control column L2 during the major part of the first test period, a pH of this order could promote the bioconversion of methane by the methanotrophs. Lastly, it is noted that no significant variation in pH can be associated with the changes in operating conditions applied to columns L1 and L2. In fact, both the introduction of leachate and the increase in flow rate had no adverse effect on the pH of the columns. However, one observes a slight reduction in the difference between the input and output pH of column L1 during the final days of the first test period. The rise in the leachate's input pH was perhaps due to the aging of the liquid and transformations that it underwent in the 200-liter tank.

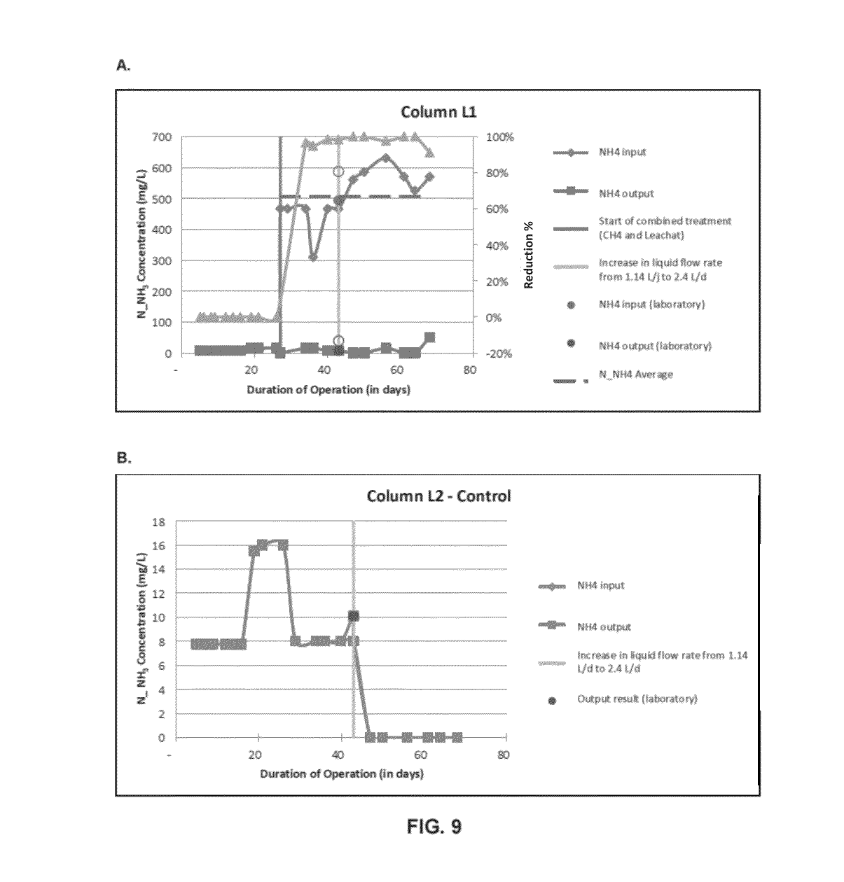

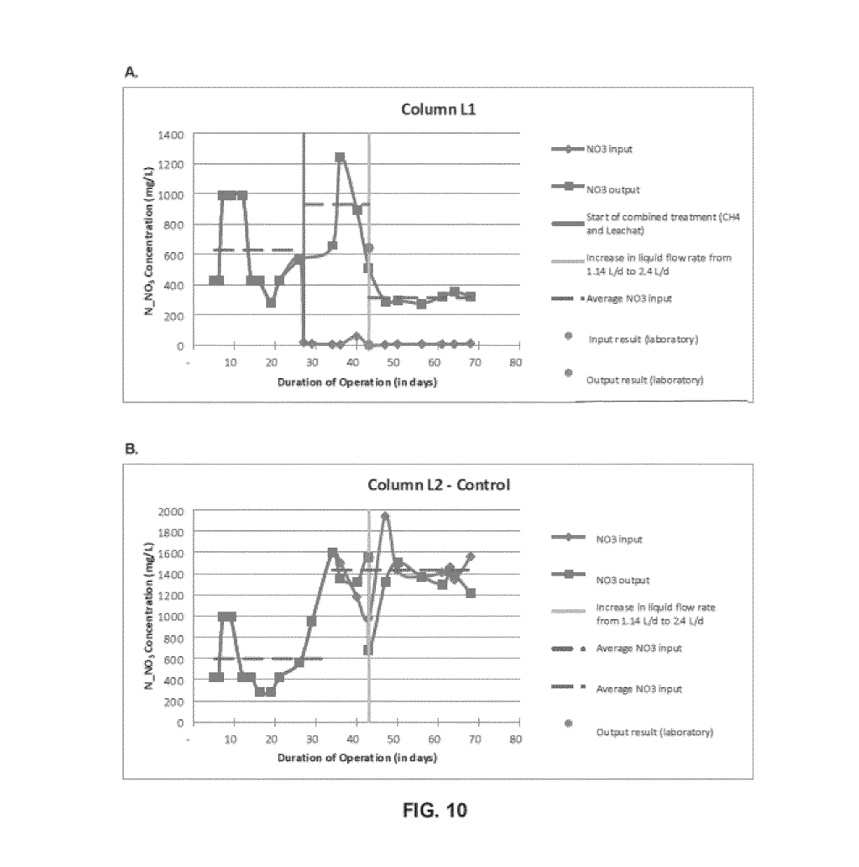

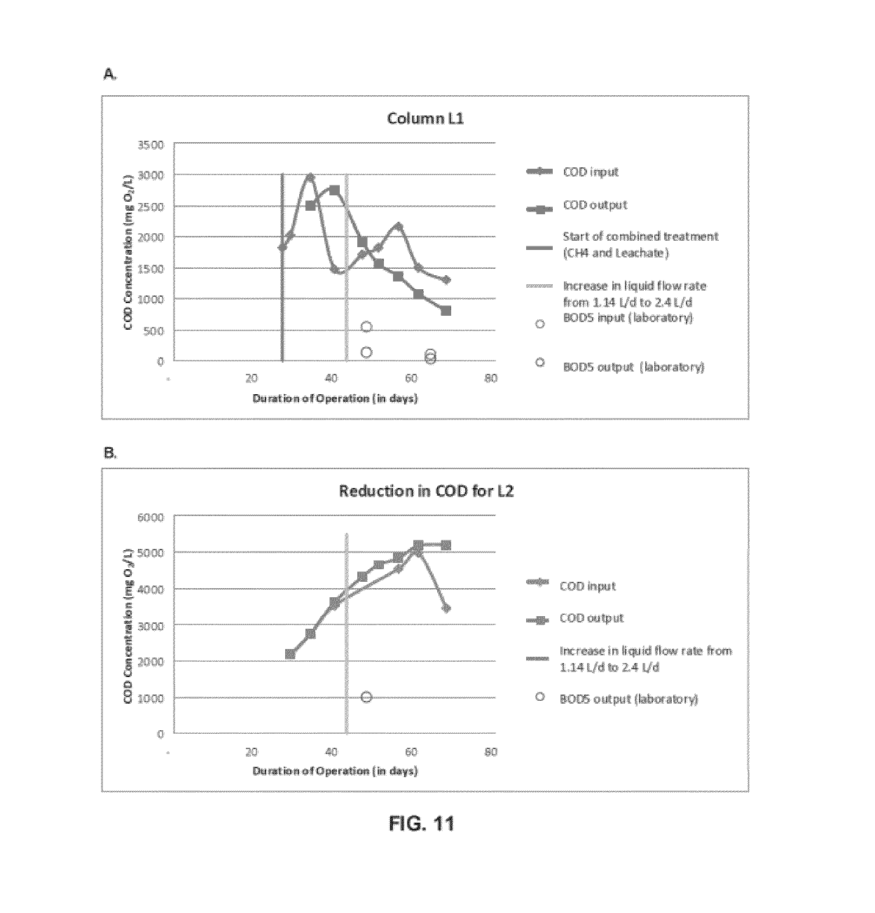

As regards nitrogenous compounds, the reduction of ammonium (NH₄) and the variation of the nitrates (NO₃) at input and output depending on the duration of operation are shown in the graphs in FIGS. 9 and 10 respectively, for both columns L1 and L2. The graph at the top of FIG. 9 shows that the column L1 achieved a considerable reduction in ammonium. In fact, concentrations fell on average from 500 mg N_NH₃/L at input to practically 0 at output. This reduction occurred from the very first days that leachate was used and continued throughout the first test period. During the high flow rate phase, the reduction in ammonium, begun during the previous phase, continued at around 95%. The increase in flow rate during this phase did not, therefore, have a negative effect on the treatment performance, which remained excellent. The graph at the bottom of FIG. 9 shows that control column L2 remained stable since the inoculum liquid contained no or very little ammonia and that, consequently, the ammonium concentrations at input and output remained zero. No comparison between columns L1 and L2 can therefore be made regarding this parameter.

The graph at the top of FIG. 10 shows that, in the case of column L1, nitrates were produced at output during the combined treatment test phase. This production could already be observed just a few days after the leachate was introduced. This generation of nitrates suggests that nitrification mechanisms became established in the filtering medium of L1. This production of nitrates from the start of the test is attributable to the inoculation of nitrifying bacteria into the medium. The presence of nitrates at output indicates that nitrates were produced in excess in column L1 and that the methanotrophs did not suffer from a lack of nitrogenous nutrients in the form of nitrates. The graph at the bottom of FIG. 10 shows that, for the control column L2, there was a reduction in nitrates at outlet compared to inlet, probably attributable to a consumption of nitrates as nutrients by the methanotrophs, said nitrogenous nutrients being in the inoculation liquid of control column L2.

As regards COD and BOD₅, the reduction of these parameters as a function of the duration of operation is shown in the graphs of FIG. 11 for both columns L1 and L2. The graph at the top of FIG. 11 shows that during the first twenty days that followed the introduction of leachate into L1, the COD measurements indicated a rise in COD at the output of L1. As the graph at the bottom of FIG. 11 shows, a rise in COD was also observed for the control column L2 on increasing the flow rate. It is possible that a leaching effect of organic material that is not readily biodegradable (color, colloidal material, COD) originating from the filtering medium could have caused these increases. It is therefore possible that a release of humic substances from the peat could have caused the observed increases in COD. After the 50th day of operation, i.e. about 5 days after the start of the third phase, a reduction in COD seems to have occurred in column L1. In fact, the last four measurements suggest that the column produced a reduction in COD of around 30%. As far as BOD₅ is concerned, the two measurements taken show an average reduction of 73%. This result suggests that column L1 was capable of biodegrading the organic matter and treating the biodegradable fraction contained in the leachate.

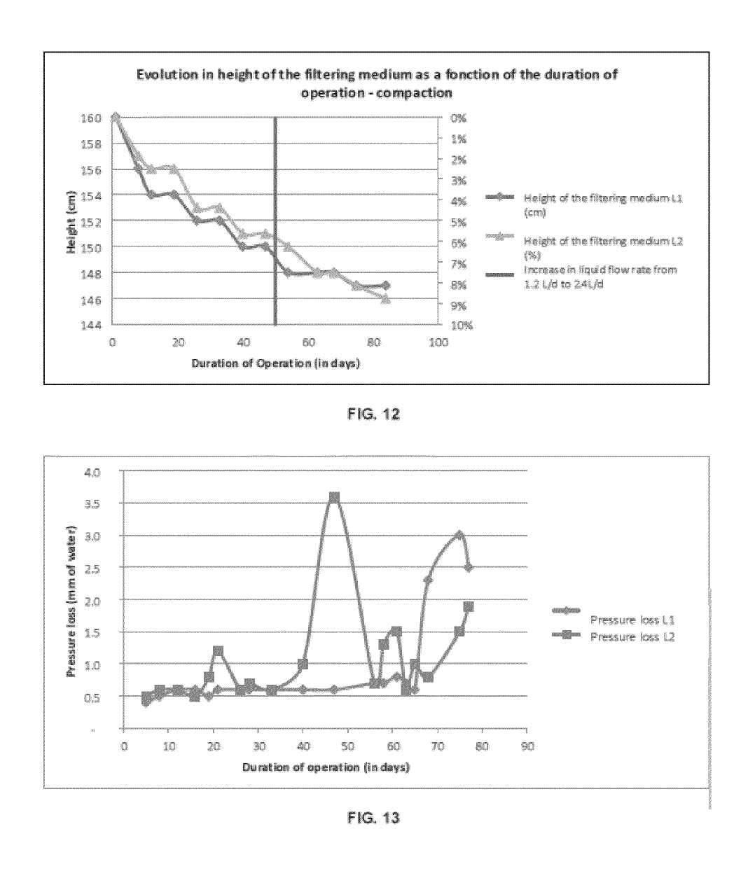

With reference to the graph in FIG. 12 showing the change in height of the filtering medium as a function of the duration of operation, it can be seen that, for both columns L1 and L2, the compaction of the filtering medium was gradual throughout the test. From the first days of the test, compaction was measurable and visually apparent and continued until the last day of the test. However, compaction slightly decreased over time so that the height of the lining fell less and less rapidly towards the end of the first test period. It will be noted that the increase in flow rate did not significantly increase the lining's compaction.

In order to assess the pressure loss of columns L1 and L2 caused by their clogging, as a function of the duration of operation during the first test period, the pressure of the gas entering the columns was measured. Since the gaseous output from the columns was at atmospheric pressure, the measurement of the pressure at inlet corresponded directly to the difference in relative pressure between the inlet and outlet, i.e. the pressure loss. The graph in FIG. 13 shows that no significant pressure loss adversely affected the operation of columns L1 and L2 during the first test period. In fact, apart from the one-off rises to 3.6 and 3.0 mm H₂O, the pressure losses of the columns were generally below 1.5 mm of water. The final higher measurements may be as a result of the increased number of water-saturated anaerobic zones, as mentioned above.

The above results of the first test period confirm the possibility of performing in one biofilter a combined treatment of methane and leachate from a TLS. For 75 days of combined treatment, it was possible to achieve significant performance levels, both for CH₄ (>90% reduction of a gas at 1% CH₄) and for the main elements present in the leachate at an application rate of 77 Lm².d (load of 0.039 kgN-NH₄/m².d=efficiency >90%—av. 11 mg/l at output; max. load 0.04 kg BOD₅/m².d=efficiency of 75%—av. 85 mg/l at output, load of 0.004 kgSM/m².d=13 mg/l at output). In fact, the EE levels were on average in the order of 95%, i.e. well above the acceptable level of 75%. The methanotrophic bacteria therefore withstood contact with the leachate well during this period, despite the presence of toxic elements in the leachate. The results obtained for ammonia reached the target of 10 mg/L. In fact, the NH₃ content dropped on average from 507 mg/L at the inlet of L1 to 11 mg/L at its outlet. The treatment of the leachate as regards this parameter therefore performed very well. Furthermore, it is interesting to note that despite its inhibiting effect, the ammonium present in the leachate did not affect the methanotrophs. For suspended solids (SS), the maximum target value of 35 mg/L at output was easily met, since output values in the order of 13 mg/L were achieved. The results showed that the combined treatment process withstood the imposition of a flow rate of leachate to be treated of 2.4 L/d, which represents a hydraulic load of 0.077 m³/m²/d, but does not necessarily represent the operating limit of the system tested. The first test period also allowed the efficiency of an inoculation and a method for starting the methane treatment process to be checked. This first test period in fact showed that, just a few days after starting, EE levels of around 95% could be obtained by inoculation. This result confirms the considerable time saving that can be achieved when an inoculation rich in methanotrophs is available at start-up.

The following section sets out the methodology and results obtained for the entire methane and leachate combined treatment test period to enable prolonged monitoring extending over almost 700 days from start-up after the acclimatization phase, and using the system described above with reference to FIG. 1. However, as from the 233^{rd} test day, biofiltration column L2, originally used as the control column treating methane, was used to treat both methane and leachate, and the results obtained were considered on the same terms as those obtained using column L1, in order to provide more experimental data on a combined methane and leachate treatment process.

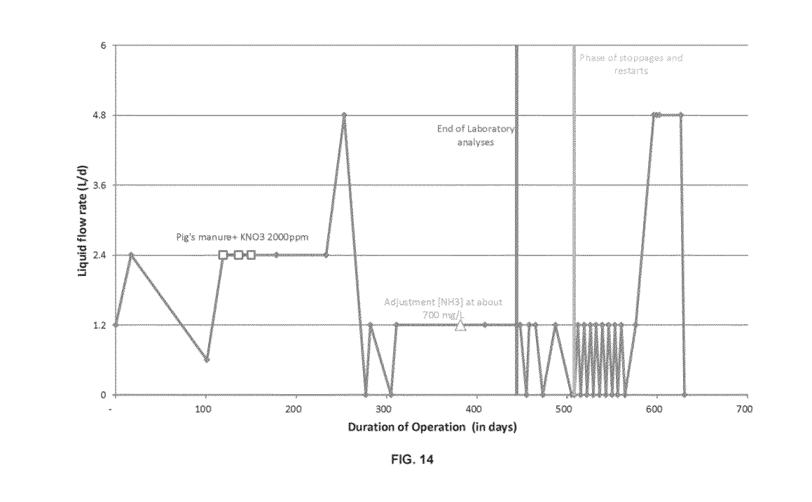

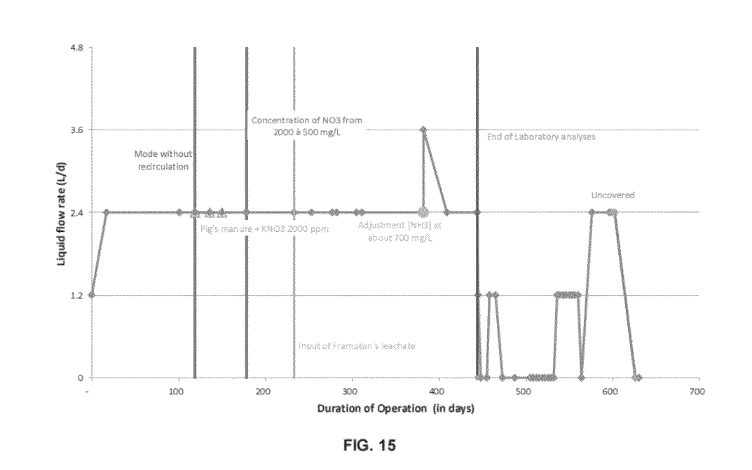

As indicated in the graph in FIG. 14 showing the change in the liquid flow rate as a result of certain interventions performed on column L1 during the test, the total duration of the test was 657 days, enabling a combined leachate and gas treatment for 631 days in column L1. The liquid flow rate varied between 0 and 4.8 L/d in an irregular manner attributable to certain changes in the purification performance of the columns, which dictated that the flow rate had to be varied several times. The gas flow rate remained at 1.2 L/d for the entire duration of the test. After the 26-day start-up period, when the leachate and an inoculum of methanotrophic microorganisms were injected in recirculation, treatment of leachate from a TLS began, corresponding to time “t=−0 d” in the graph in FIG. 14. The liquid flow rate varied irregularly between 0 and 4.8 L/j for almost the entire duration of the test, except between days 508 and 560, when a series of regular stops/start-ups was tested (varying from 0 to 1.2 L/d.) The nitrate concentration had to be adjusted on days 119, 136 and 156 with the addition of KNO₃. The ammonium concentration had to be adjusted on day 382. On day 444 some laboratory analyses for certain parameters were stopped.

As indicated in the graph in FIG. 15 showing the change in the liquid flow rate as a result of certain interventions performed on column L2 during the test, the liquid flow rate varied between 0 and 3.6 L/d and was relatively more constant than that of column L1, particularly in the first half of the test. On the 119^{th} day, the feed comprised pig's manure whose NO₃ concentration was adjusted. On day 233, the treatment of TLS leachate was begun. The NH₃ concentration had to be adjusted on day 382. Operations were stopped for about 60 days between the 473^{rd} and 536^{th} day and were then resumed at a constant flow rate for about 30 days.

The following section presents an analysis of the test results over the entire period of monitoring biofiltration columns L1 and L2. Tables 6 and 7 show, for columns L1 and L2 respectively, the statistical data (minimums, maximums, averages, standard deviations) of the main parameters that were measured mainly in the laboratory and formed the subject of the analysis of the results. Some data were obtained using a colorimeter when the number of laboratory analyses was deemed insufficient.

TABLE 6

| | Statistical data - Column L1 | | | | | | | |
|---|---|---|---|---|---|---|---|---|
| | Minimum | | Maximum | | Average | | Standard deviation | |
| Parameters | Input | Output | Input | Output | Input | Output | Input | Output |
| BOD₅ (mg O₂/L) | 67.0 | 6.0 | 680.0 | 135.0 | 219.4 | 20.0 | 164.0 | 27.8 |
| COD (mg/L) | 523 | 332 | 2980 | 2750 | 1390 | 860 | 528.5 | 658 |
| NH₃ (mg/L) | 133.1 | 2.5 | 785.7 | 29.1 | 578.7 | 5.7 | 171.6 | 6.1 |
| SS (mg/L) | 25.0 | 6.0 | 234.0 | 92.0 | 67.1 | 27.0 | 44.1 | 23.4 |
| pH | 7.5 | 7.8 | 8.7 | 9.2 | 8.1 | 8.6 | 0.3 | 0.3 |
| NO₃ (mg/L) | <1 | <1 | 2390 | 2360 | 486.1 | 612.8 | 742.1 | 619.9 |
| Coliforms (CFU/100 ml) | 1 | 1 | 540 | 10 | 147.1 | 3.9 | 192.6 | 4.2 |
| [CH₄] (%) | 0.70 | 0.02 | 2.6 | 0.72 | 1.1 | 0.18 | 0.15 | 0.18 |

| | | | | |
|---|---|---|---|---|
| EE_{CH4} (%) | 29.0 | 99.0 | 83.0 | 16.0 |
| EC (g/d/m³) | 0.0 | 21.0 | 6.2 | 3.3 |

It will be noted that in Table 6, the maximum NO₃ input value was obtained during the external addition of nitrates, and that the maximum and average [CH₄] input values were 1.2, 1.1 and 0.07 respectively after eliminating identified aberrant data.

TABLE 7

| | Statistical data - Column L2 | | | | | | | |
|---|---|---|---|---|---|---|---|---|
| | Minimum | | Maximum | | Average | | Standard deviation | |
| Parameters | Input | Output | Input | Output | Input | Output | Input | Output |
| BOD₅ (mg O₂/L) | 67.0 | 7.0 | 580.0 | 69.0 | 220.7 | 23.9 | 173.7 | 18.5 |
| COD (mg/L) | 410 | 360.5 | 4980 | 5210 | 1873.2 | 1920 | 1290.5 | 1825.5 |
| NH₃ (mg/L) | 133.1 | 2.8 | 835.5 | 16.3 | 628.0 | 5.9 | 195.5 | 4.6 |
| SS (mg/L) | 31.0 | 4.0 | 234.0 | 336.0 | 73.7 | 62.9 | 52.5 | 91.8 |
| pH | 7.4 | 7.4 | 9.2 | 9.2 | 8.4 | 8.7 | 0.5 | 0.4 |
| NO₃ (mg/L) | 1 | 88.5 | 2390 | 2130.0 | 909.8 | 964.7 | 819.1 | 617.9 |
| Coliforms (CFU/100 ml) | 100 | 10 | 450 | 10 | 223.3 | 10 | 196.6 | 0 |
| [CH₄] (%) | 0.79 | 0.01 | 2.6 | 0.69 | 1.1 | 0.18 | 0.16 | 0.17 |

| | | | | |
|---|---|---|---|---|
| EE_{CH4} (%) | 28.0 | 99.0 | 84.0 | 17.0 |
| EC (g/d/m³) | 0.0 | 19.4 | 6.1 | 3.5 |

It will be noted in Table 7 that the maximum NO₃ input value was obtained during the external addition of nitrates.

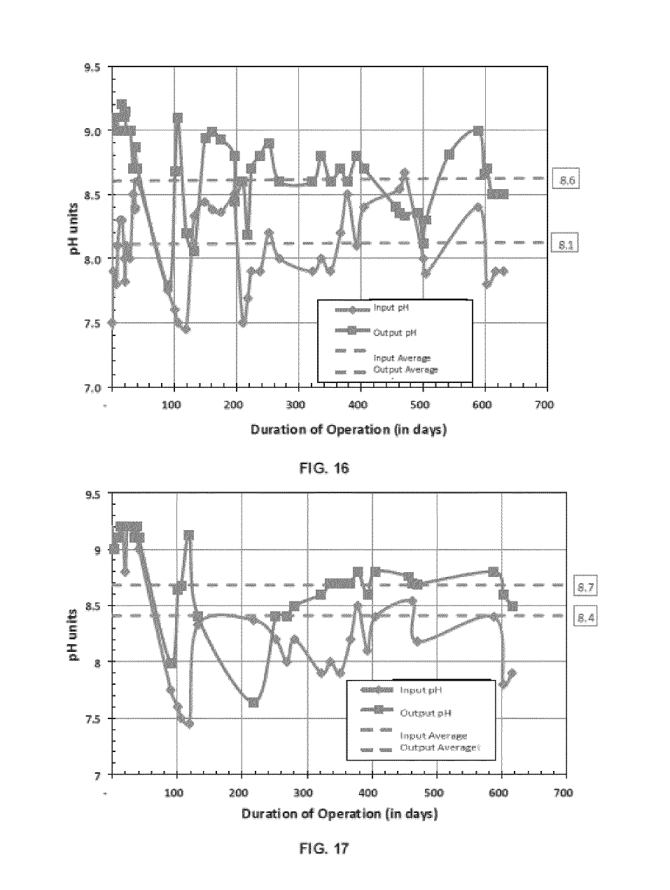

As for the pH, the aim for this parameter was to stay between values of 6 and 9.5, which was achieved for column L1. The average pH at input was 8.1 and at output 8.6. During the biofiltration process, production or transformation of one or more substances responsible for the rise in pH therefore occurred. In fact, the nitrification process (biotransformation of ammoniacal nitrogen to nitrate) should have caused the pH to fall. In any event, the average pH at output was slightly above the optimal pH of methanotrophic bacteria (between 5.5 and 8.5), but within the optimal pH zone of nitrifying bacteria (between 8 and 9). By contrast, the pH having been measured at the output of the columns, and considering that the methanotrophic and nitrifying microorganisms do not colonize the lining in the same place, the measurement obtained was therefore a general indication of the pH within the biofiltration columns. In the graph in FIG. 16 showing the changes in pH for column L1, it will be observed that there was no difference or major change in the values of this parameter. The fact that the stoppage and start-up periods coincided with a slight increase in pH is explained by the low level of nitrification prevailing during this period.

In the graph in FIG. 17 showing the changes in pH for column L2, it will be observed that the aim of keeping the pH between 6 and 9.5 was also achieved. In fact, the mean pH at input was 8.4 and at output 8.7. The pH increased a little during the test for column L2, as was the case with column L1 and for the same reasons. The liquid recirculated at the start of the test appeared to have a higher pH that the TLS leachate, which would explain the first peak observed at the inlet and at the outlet. There was no difference or major change in the pH values.

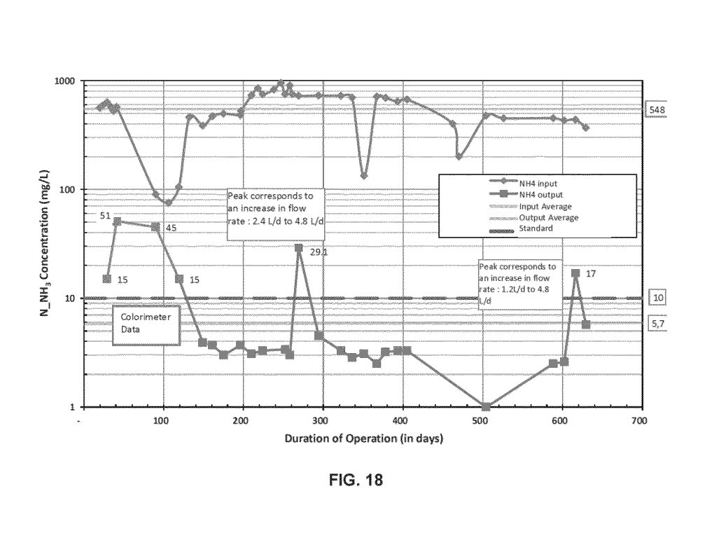

As regards monitoring ammoniacal nitrogen (NH₃) even though like some of the other substances contained in TLS leachates, its concentration can vary considerably, the discharge standard of a maximum of 10 mg of NH₃/L should be found during the test. In the graph in FIG. 18 showing the changes in N_NH₃ concentration for column L1, it will be observed that on average, a concentration of 548 mg/L at input and 5.7 mg/L at output was measured during the test, thus meeting this standard. Biofiltration column L1 therefore benefited from an efficient activity of the microorganisms responsible for nitrification. However, it will be noted that during the first 150 days of operation of column L1, the N_NH₃ values often exceeded 10 mg/L. It may be that the nitrifying biomass was not yet fully established at the start of the test, causing incomplete bioconversion of the ammonia.

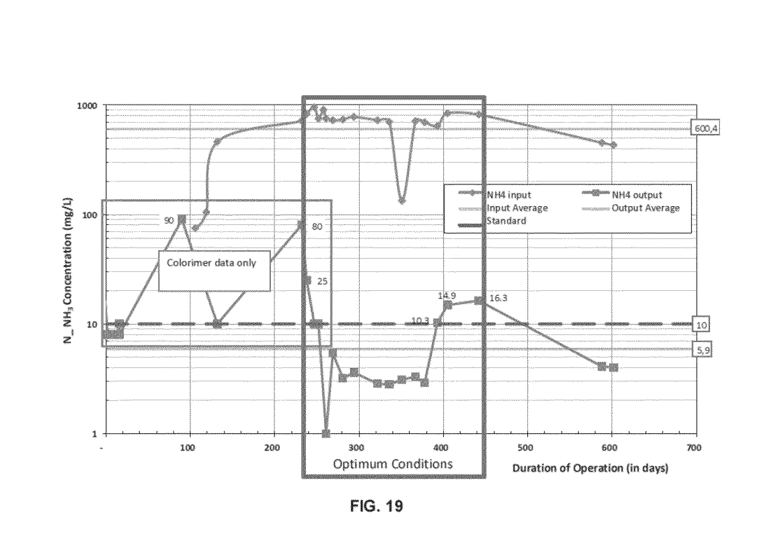

In the graph in FIG. 19 showing the changes in N_NH₃ concentration for column L2, the discharge standard of 10 mg of NH₃/L maximum was also met, despite a few undesirable increases in N_NH₃ concentration at the output. The high value on day 90 could be explained by the fact that the nitrifying biomass was not yet efficiently established, attributable to a very low NH₃ input at the start of the test, thus offering very little substrate for the nitrifying microorganisms.

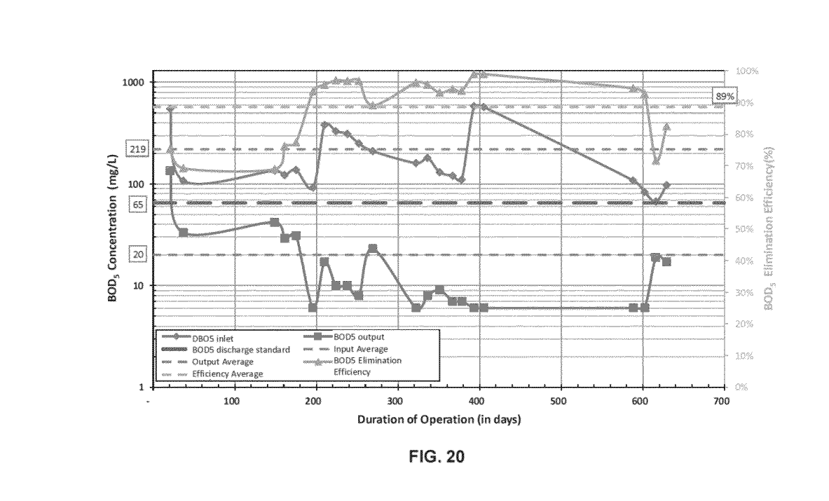

As regards monitoring the BOD₅, which gives an indication of the amount of O₂ used by the microorganisms over a period of 5 days (the higher its value, the greater the amount of biodegradable organic material), the graph in FIG. 20 shows the changes in this parameter for column L1. It will be observed that the standard of 65 mg/L was met, since an average value of 20 mg/L was observed in column L1. By contrast, during the first 30 days at the start of the test, output values of BOD₅ that exceeded this standard were observed, which could be explained by a very high BOD₅ level at the start of the test and by the large amount of organic matter (OM) in the filtering medium being purged before starting up the column after inoculation.

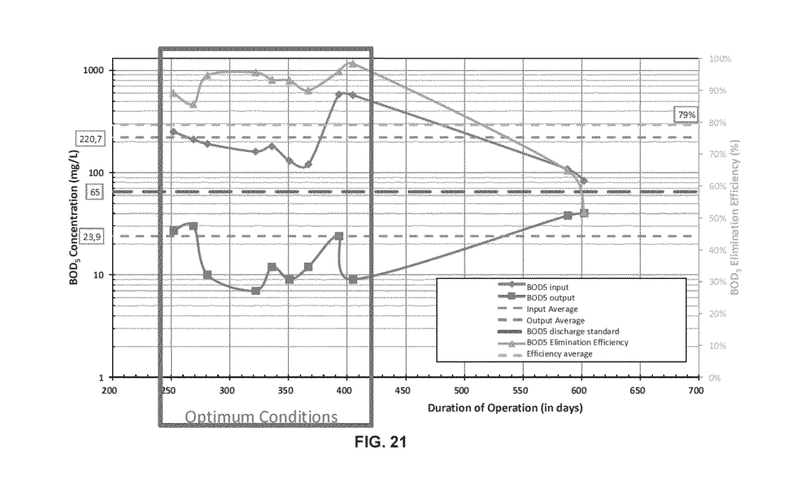

As regards monitoring the BOD₅ for column L2, the graph in FIG. 21 shows the changes in this parameter for this column. As average values of 220.7 mg O₂/L at input and 23.9 at output were observed, column L2 enabled the organic material (OM) contained in the leachate to be treated efficiently, meeting the standard of 65 mg/L. Despite values that were on occasion very high at inlet, the output values stayed very low (<40 mg O₂/L).

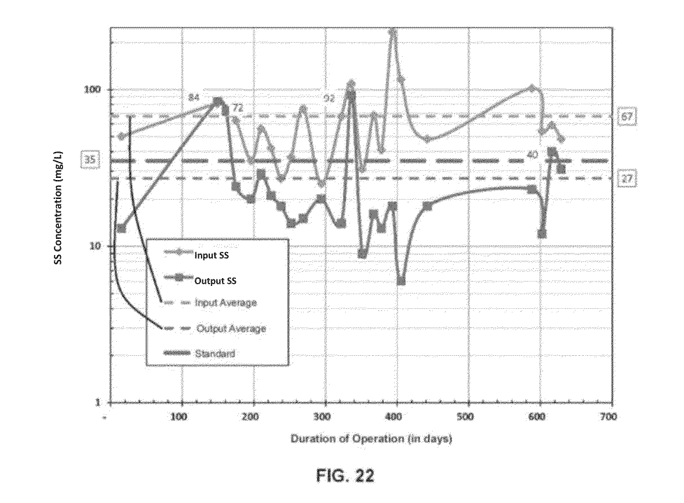

As regards monitoring suspended solids (SS) for column L1, the graph in FIG. 22 shows the development of this parameter for this column. It will be observed that, on average, the SS concentration at input is higher than at output. The biofilter thus allows some of the suspended solids in the feed liquid to be trapped. The average output value of 27 mg/L is below the standard of 35 mg/L. The peak on day 149 could be explained by the increase in flow rate in the days preceding this measurement. It is, however, normal for the biofiltration column to reject a certain amount of SM as a function of input concentrations and occasional leaching or release, as could have been the case with the peak on day 336. Higher liquid flow rates could also have caused a greater release of SS than at lower flow rates.

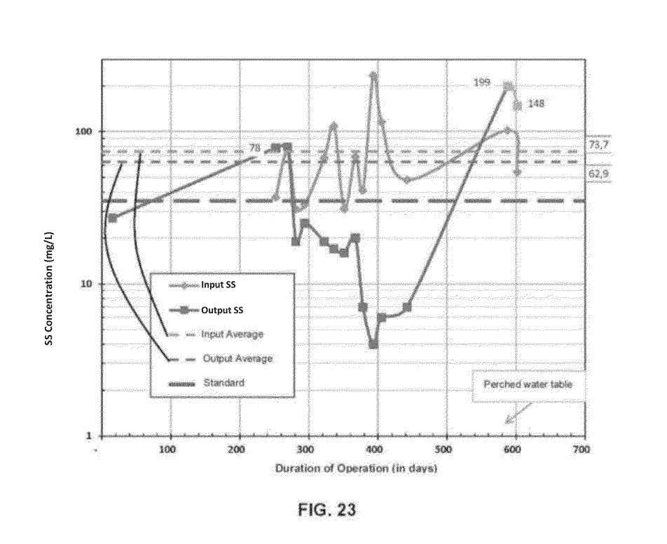

As regards monitoring SS for column L2, the graph in FIG. 23 shows the development of this parameter for this column. The average of the SM input values was 73.7 mg/L, the output average being 62.9 mg/L. This relatively high output value could be explained by the fact that most of the data was taken over a period of about 150 days, whereas the duration of the test was almost 700 days.

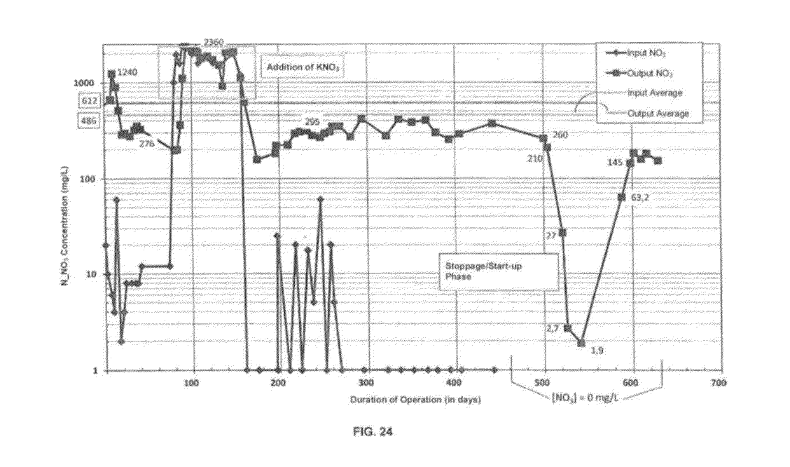

As regards monitoring the nitrates (NO₃), the graph in FIG. 24 shows the evolution of this parameter for column L1. The high values at the beginning of operation are explained by the fact that nitrates were added (in the form of KNO₃ fertilizers) in order to supply the nutrients necessary for the metabolism of the methanotrophic microorganisms at the beginning of operation. Moreover, the nitrifying microorganisms were inoculated at the beginning of the test, explaining some of the nitrate production. The denitrifying biomass being anaerobic and the filter operating by percolation (few anaerobic zones), it is normal for the output concentration to be high. When the addition of nitrates ceased (around the 140th day), the production of nitrates was efficient. The methanotrophic microorganisms must have had a sufficient amount of nitrates because the concentration at output was relatively high. Otherwise, if it had been very low or zero, the nitrates would have been identified as reactants limiting methane in the oxidation reaction. In the period of alternating stoppages and restarts (around the 500th day), the production of nitrates was practically zero, while the concentration of NH₃ at input was around 450 mg/L. The concentration of ammoniacal nitrogen (N_NH₃) at output remained very low, however, suggesting that nitrification was not complete. When this period ended (just before the 600th day), the production of nitrates resumed. It is desirable for the nitrate concentration at output to be low. By contrast, the conversion of methane during this period having been less efficient, leads us to believe that the methanotrophic microorganisms lacked a sufficient supply of nitrogenous nutrients (e.g. nitrates).

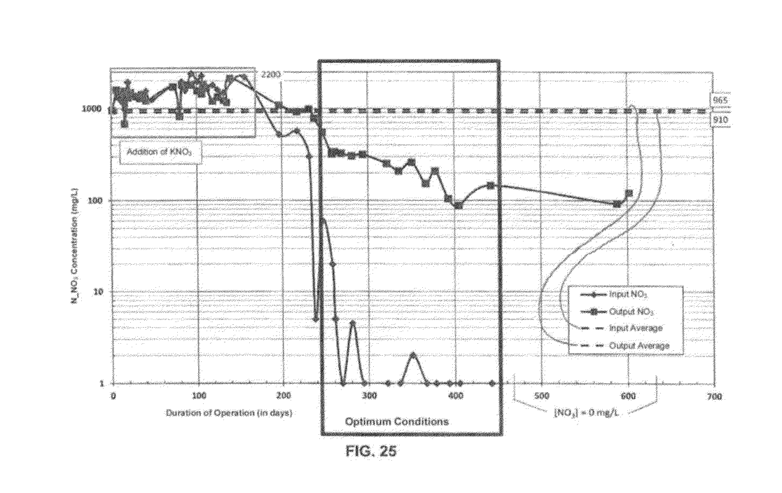

As regards monitoring the nitrates (NO₃) for column L2, the graph in FIG. 25 shows the evolution of this parameter for this column. The high values of NO₃ at the beginning of operation for L2 are explained by the fact that nitrates from an external source were added in order to provide the substrates required to establish methanotrophic microorganisms at the beginning of operation. Moreover, since nitrifying microorganisms were inoculated at the beginning of the test, this partly explains the production of nitrates. As the denitrifying biomass is anaerobic and the filter operates by percolation (involving a relatively large diffusion of additional oxygen and injecting air into the system), it is normal for the nitrate concentration at output to be high. When the addition of nitrates ceased (on day 232), it will be observed that the concentration at input was almost zero and that it was on average around 200 mg/L at output.

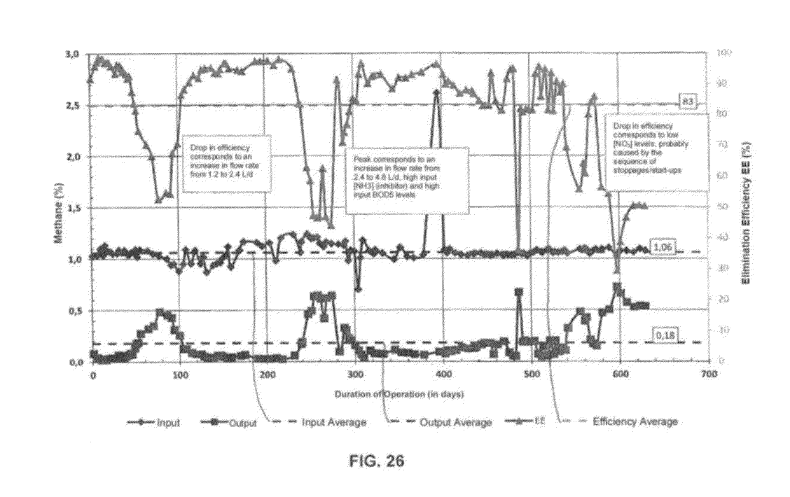

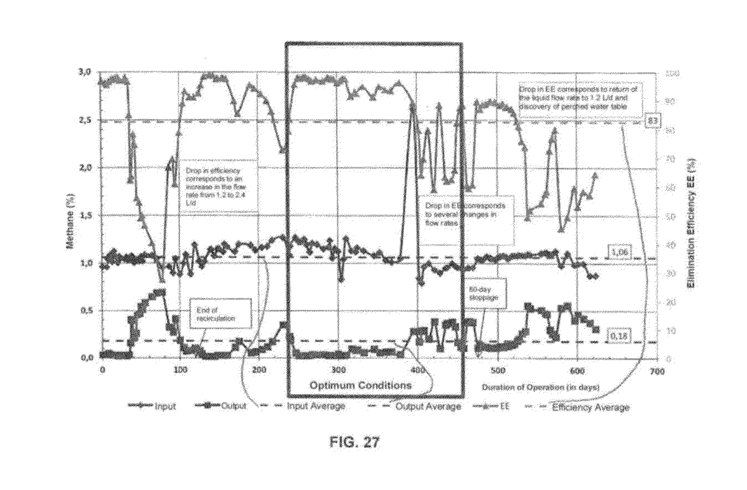

As regards monitoring methane (CH₄), the graph in FIG. 26 shows the evolution of this parameter for column L1. It will be observed that on average, the methane concentration at the inlet of column L1 was 1.06% (v/v), while at the outlet it was 0.18% (v/v), resulting in an average methane conversion efficiency of 83%. The aim of an average efficiency of over 75% was therefore achieved for column L1. The reduction of methane appears to be affected quite considerably by the changes in the liquid flow rate. The treatment of methane during the start-up period was efficient because an inoculum rich in methanotrophs was injected. The replacement of the feed liquid by leachate on day 0 could partly explain the peak triggered around the 20th day, coinciding with a liquid flow rate that was doubled on the 17th day. This peak therefore seems to indicate an adaptation reaction of the filtering medium both to the new agents present in the leachate and to the greater hydraulic load. By contrast, one can also see that the elimination efficiency picks up around the 80th day, corresponding to the start of the external addition of nitrates, which may mean that the nitrate requirements of the methanotrophs were not met at the start of the test. Despite the injection of an inoculum of nitrifying bacteria during the start-up period, the nitrate concentration at the outlet of the biofilter at the beginning of the test remained high. This gives reason to believe that the microorganisms were not sufficiently well established in their optimum zone of activity. Thus, a large proportion of the nitrates could have been produced in the zones at the bottom of the biofiltration columns where there were fewer methanotrophic microorganisms, explaining the high nitrate concentrations, but with a downward EE until the addition of nitrates. The peak between the 200th and 300th day corresponds to an increase in the liquid flow rate from 2.4 L/d to 4.8 L/d, this same peak corresponding to high NH₃ input values, having an inhibiting effect on the methanotrophic microorganisms. Moreover, it will be noted that the BOD₅ input values are also high during this period, as the graph in FIG. 20 shows. The drop in EE at the end of the tests seems to have been caused by the sequence of stops and start-ups occurring round the 500th day. The nitrates at output were then practically absent so could not therefore meet the needs of the methanotrophic microorganisms.

As regards monitoring the methane (CH₄) in column L2, the graph in FIG. 27 shows the development of this parameter for this column. During the test, the average concentration of methane at input was 1.06% (v/v) and 0.18% (v/v) at output. The average CH₄ elimination efficiency (EE) was 83% for column L2, much higher than the acceptable value of 50%. The treatment of methane therefore bolsters the treatment of the leachate, the aim being to achieve the highest possible methane EE value, without adversely affecting treatment of the leachate. Thus, when the efficiency of the methane treatment drops, some interventions could be made without however having a detrimental effect on the treatment of the liquid. The inoculation liquid injected at the start of the test seems to have enabled the methanotrophic microorganisms to be efficiently established in the medium, since the treatment of methane was effective since time 0. The first peak observed (around the 29th day) for column L2 corresponds to an increase in the liquid flow rate from 1.2 Ld to 2.4 L/d, as observed also in column L1. As mentioned above, it appears that the methanotrophic bacteria are affected by changes in feed flow rates. Moreover, the fact that the feed liquid was always recirculated during this period enabled certain inhibiting substances (e.g. metabolic waste or potassium) to be concentrated for the methanotrophic microorganisms. The slight variations starting at around the 380th day coincide with changes in the liquid flow rate (an increase in flow rate of 2.4 L/d to 3.6 L/d, as well as with a reduction from 2.4 L/d to 1.2 L/d), and to a short series of stoppages and start-ups ending with the stoppage of liquid feed on the 473rd day for about 60 days. During this stoppage, the EE levels were more constant and higher, until the liquid flow rate resumed at 1.2 L/d. This means that for a few weeks, there were sufficient quantities of the substrates that use methanotrophic microorganisms and that the medium contained some in reserve. The EE levels were about 55% for the rest of the test.

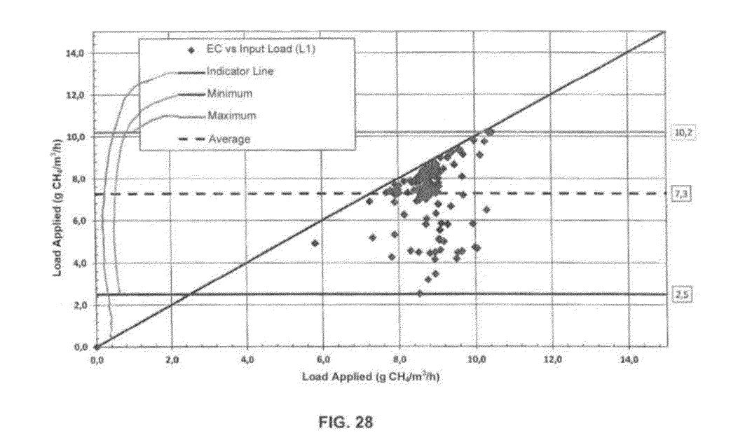

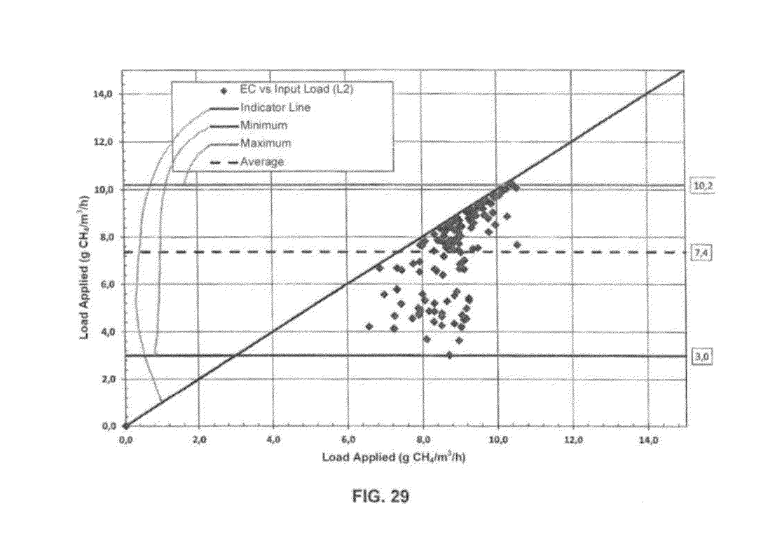

As regards the methane elimination capacity (EC), the graph in FIG. 28 shows the development of this parameter as a function of the methane applied load (AL) for column L1. With the operating parameters previously mentioned, it was possible to achieve a maximum elimination capacity of 10.2 g/m³/h. A minimum EC of 2.5 g/m³/h and an average EC of 7.3 g/m³/h were obtained.

As regards the methane elimination capacity (EC) for column L2, the graph in FIG. 29 shows the evolution of this parameter for this column as a function of the methane applied load (AL). As with column L1, it was possible to achieve a maximum elimination capacity of 10.2 g/m³/h. A minimum EC of 3.0 g/m³/h and an average EC of 7.4 g/m³/h were obtained.

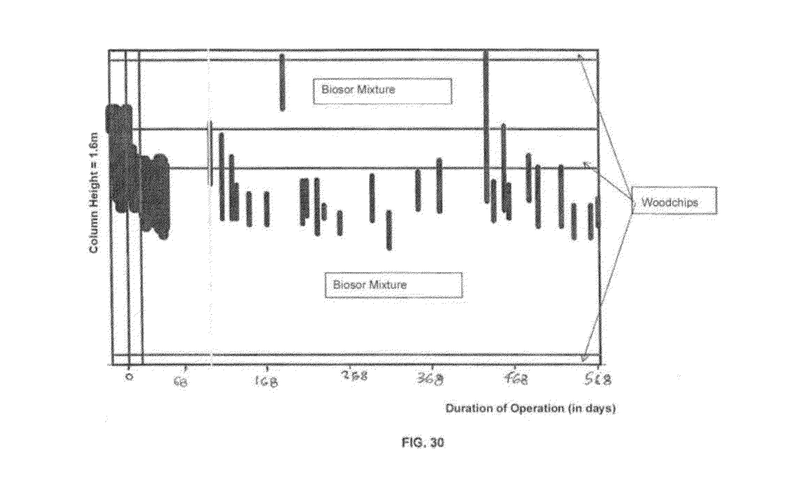

As regards the active methane treatment zones, the graph in FIG. 30 shows the development of these active treatment zones as a function of time for column L1. The heights of the woodchip zones and organic mixture zones are to scale with the column, which is 1.6 m high. The dark bars indicate the hottest zones in relation to the rest of the lining. The bottom and top limits of these bars were determined on the basis of 0.5° C. increments with the hottest recorded temperature being on the walls of the column. The temperatures were taken up the entire height of the column using an infrared thermometer, Model OS562, supplied by Omega Engineering (Stamford, Conn.). Considering that the oxidation of methane by methanotrophic bacteria is an exothermic reaction, the heat released by these bacteria increases the temperature of the zone where they are most active. The graph in FIG. 30 shows that the hot zones are concentrated mainly above the middle zone of the woodchips or at the top of the bottom zone of the organic mixture Given that the column operates by percolation, it is possible that the heat released by the microorganisms is drawn downwards by heat transfer with the flowing liquid. An increase in the liquid flow rate would therefore cause a downward movement of the apparent active zone, which could explain the movements of the hot zones. If that happens, the zone where the majority of the methanotrophic microorganisms appear to be established would be the intermediate zone of the woodchips. This zone is extremely porous, thus promoting gas diffusion, and its specific surface could promote the establishment of microorganisms. This could also be explained by the fact that this zone is located at the height where the concentrations of nitrates, inhibiting substances and gas are optimal for the methanotrophic microorganisms. For example, the high NH₃ concentrations contained in the leachate at input would risk inhibiting the activity of the methanotrophic microorganisms. It will be noted that lower down the column L1, as most of the NH₃ was transformed into nitrates by the nitrifying bacteria, the nitrates then served as a substrate for the bioconversion of methane.

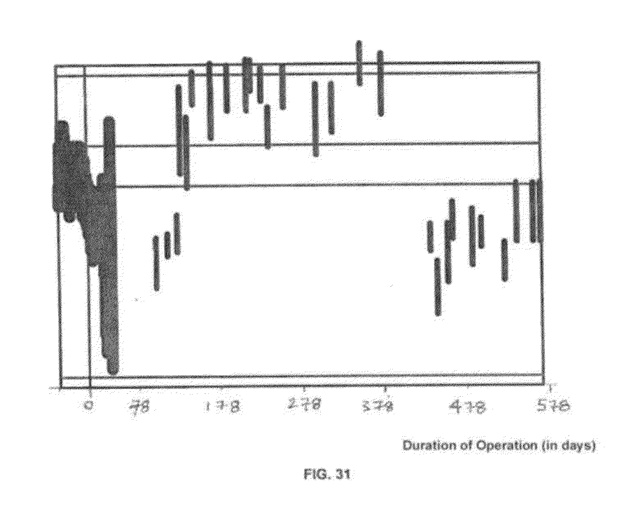

As regards the active methane treatment zones for the test in column L2, the graph in FIG. 31 shows the development of these active treatment zones as a function of time for this column. The behavior of the active zones observed in column L2 is very different from that observed in column L1. In fact, in column L1, the hot zones are mainly located slightly above the intermediate zone of the woodchips throughout the entire duration of the test. By contrast, for column L2, three periods corresponding to very distinct zones of activity are observed. At the start of the test, the active zone is directly within the intermediate zone of the woodchips and then moves slightly downwards, corresponding to an increase in the liquid flow rate. The second period is characterized by active zones concentrated at the top of the woodchips and organic mixture of the filtering medium. Then, during the third period, the active zone returns slightly above the intermediate zone of the woodchips.

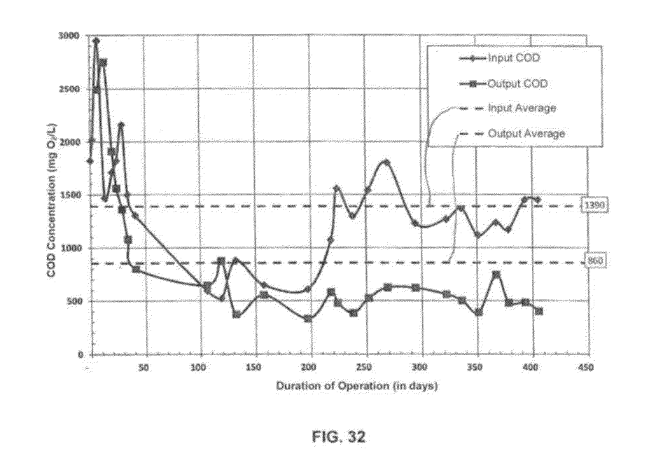

As regards monitoring the chemical oxygen demand (COD), considering that this parameter is not covered by the standard considered for the purposes of the test, it was monitored as an indicator. The graph in FIG. 32 shows the reduction in COD as a function of the duration of operation for column L1. The COD data were gathered over 405 test days. On average, the COD values were 1390 mg O₂/L at input and 860 mg O₂/L at output, which is relatively high, corresponding to an average reduction of 38%. One can therefore conclude that there was a chemical consumption of oxygen, probably by oxidation-reduction reactions. As the COD gave an indication of the pollutant load contained in the liquid to be treated via the amount of oxidizable organic material, to a certain extent biofiltration column L2 enabled the leachate to be purified. The color of the liquid at outlet indicated that oxidizable compounds were present in the form of colloids or suspended solids.

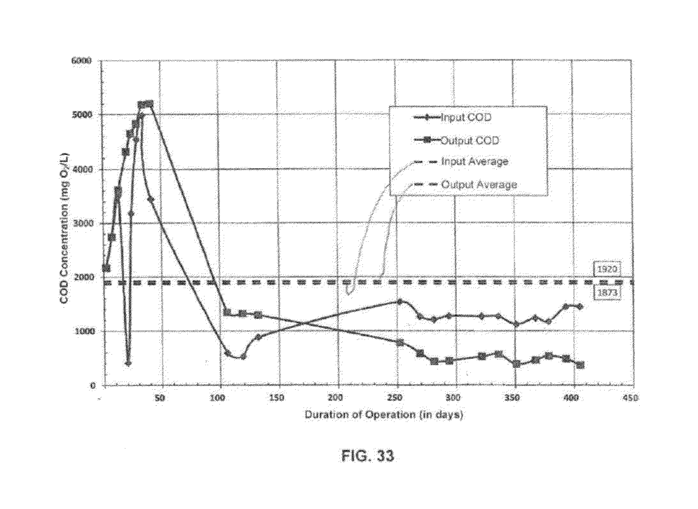

As regards monitoring the COD for column L2, the graph in FIG. 33 shows the reduction of this parameter for this column. As with column L1, COD data were gathered up to the 405th day, no data having been collected between the 132nd and 252nd day. The average values were 1873 mg/L at input and 1920 mg/L at output, being explained by the very high COD values observed at the start of the test, whereas for several weeks preceding the 405th day, the COD values observed at output were lower than those observed at input.

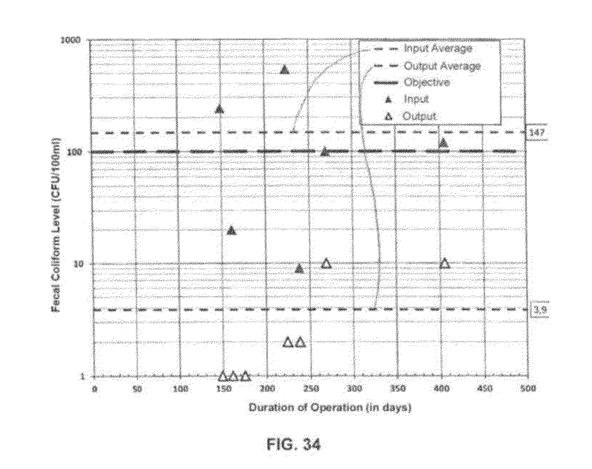

As regards monitoring the fecal coliform level, the graph in FIG. 34 showing the development of this parameter as a function of the duration of operation for column L1 shows that the objective of keeping the concentration of fecal coliforms below 100 CFU/100 ml was achieved for column L1. In fact, the average values were 147 CFU/100 ml at input and 3.9 CFU/100 ml at output, well below the set limit value. Although this parameter was monitored only for a period of less than 300 days, i.e. less than half the duration of the test, as the concentrations measured at output were very low compared to the set limit, one can expect this treatment to be effective in reducing the fecal coliform level over a longer period than that monitored.

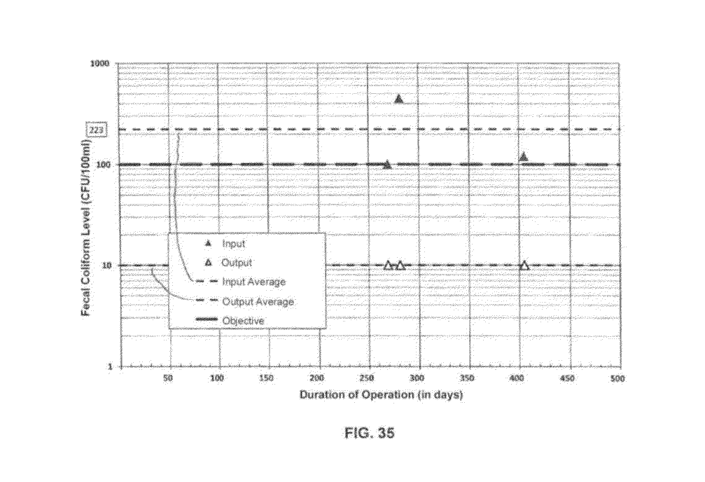

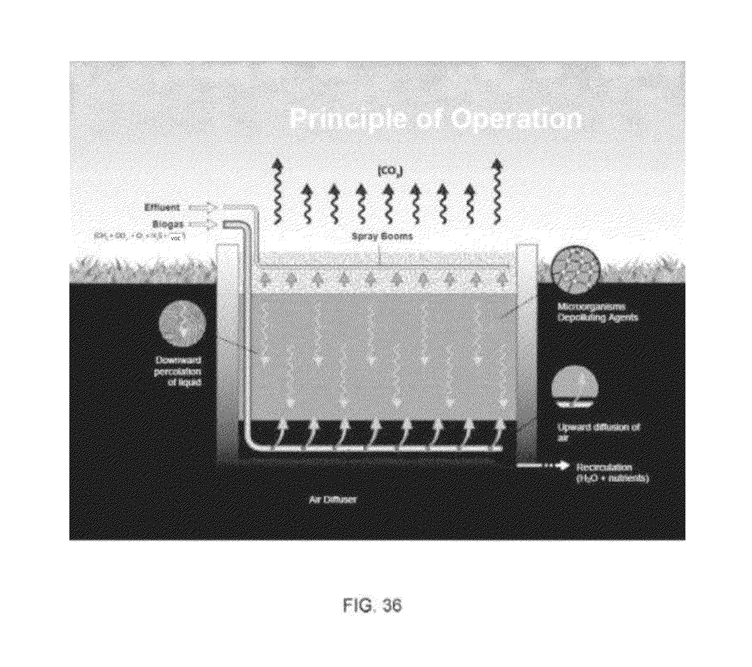

As regards monitoring the fecal coliform level for column L2, the graph in FIG. 35 showing the development of this parameter for this column shows that, as with column L1, the objective was also achieved for column L2. In fact, the average values were 223 CFU/100 ml at input and 10 CFU/100 ml at output. Although only 3 measurements were taken at input and output and none of these points is at the beginning or end of the test, one can still expect that the performance of column L2 would be is similar to that of column L1 and so the reduction in coliforms would be efficient over a longer period than that monitored.

The purpose of the successive stoppages and re-starts that occurred during the test was to observe the behavior of the biofiltration columns in response to this method of operation. Although it was observed that the elimination efficiency increased somewhat during certain stoppages of liquid feed, the elimination capacity fell to 56%, whereas it was nearly 90% before beginning the successive stoppages and restarts. This loss of performance could be explained by the fact that the production of nitrates fell almost to zero. Thus, the methanotrophic microorganisms may have lacked nutrients, reducing by this fact their capacity to oxidize the methane. Moreover, these microorganisms seem to be relatively seriously affected by changes in the liquid flow rate, which could explain the drop in performance levels observed earlier during the test.

In summary, the results of the test that extended over 631 days confirmed that all of the objectives set for biofiltration column L1, operating in methane and TLS leachate combined treatment mode, were met. It was possible to achieve an EE of CH₄=83%, an average N_NH4 at output of 5.7 mg/l, an average BOD₅ at output of 20 mg/L, average pH values at output of 8.6, an average SS at output of 27 mg/L and average fecal coliform levels at output of 3.9 CFU/100 ml. Just as all of the performance criteria were met, so too did the process tested in L1 prove to be efficient for the simultaneous combined treatment of gaseous effluents containing methane and TLS leachates.

As regards biofiltration column L2, it was possible to achieve an average CH₄ EE of 83%, an average N_NH4 at output of 5.9 mg/L, an average BOD₅ at output of 23.9 mg/L, average pH values of 8.7 and average fecal coliform levels of 10 CFU/100 ml. Only the average SS of 62.9 mg/L observed for column L2 failed to achieve the set objective.

It was observed that changes in the liquid feed flow rate affect the bioconversion of methane. As the concentrations at inlet are already very variable, the fact of drastically changing the feed flow rate, by doubling it for example, would involve a major adaptation of the biofiltration system on an operational level. A constant-flow method could therefore prove advantageous in this case. If changes in flow rate should prove necessary, they could be applied gradually over a longer period of time.

The phase of stoppages and restarts carried out during the test involved a succession of 4-day periods of feeding liquid at 1.2 L/d followed by 3-day stoppages, for nearly 60 days. At the start of this phase, the CH₄ elimination efficiency was not affected, unlike the nitrification process. In fact, the production of nitrates was greatly influenced during this phase, dropping from 210 mg NO₃/L to 1.9 mg NO₃/l at output a few days after the start of this phase. As nitrates form an important substrate for methanotrophic microorganisms, their absence definitely has an adverse effect on methane elimination efficiency. This is borne out by the fact that the CH₄ EE dropped from 90% to 56% in 17 days. The reduction in nutrients was by no means the only cause for this reduction. In fact, for both column L1 and L2, all of the reductions in efficiency occurred during changes in liquid flow rate. So, as this phase is characterized by frequent changes in flow rates, the methanotrophic microorganisms could have been negatively affected by these changes in operating conditions. The ideal situation would be for the level of nitrates at output to be low but without affecting the treatment of methane. Moreover, an operating method involving successive reductions and increases in the liquid flow rate could be applied with the aim of reducing the adaptation needs of the methanotrophic microorganisms.

In the graphs showing the active treatment zones, it is possible to determine the place where the methanotrophic microorganisms are more likely to be established, namely in the intermediate woodchip zone.

1. A process for the simultaneous treatment of a gas containing methane and a liquid effluent containing ammonium or nitrates and other toxic pollutants, said process comprising the following steps:
a) performing a biofiltration of said effluent by percolation on a filtering medium comprising an organic material, at least one portion of said organic material supporting the growth of microorganisms degrading said pollutants in order to convert said ammonium into nitrates and to degrade said other pollutants; and
b) simultaneously directing said gas upwards through said filtering medium in an aerobic condition;
wherein said nitrates contained in said effluent or produced from said ammonium serve as a nutrient for the growth of methanotrophic microorganisms in said filtering medium, said methanotrophic microorganisms being adapted to convert said methane into biomass and carbon dioxide via an exothermic reaction, thus producing an amount of heat to keep the temperature of at least one portion of said filtering medium within an operational range for said conversion of the methane and the degradation of said pollutants.

2. The process according to claim 1, wherein said operational temperature range lies between 15° C. and 45° C.

3. (canceled)

4. The process according to claim 1, wherein said temperature range is maintained due to an adjustment of the effluent flow rate.

5. The process according to claim 1, wherein said temperature range is maintained due to an adjustment of the effluent load.

6. The process according to claim 1, wherein said methanotrophic microorganisms are methanotrophic bacteria.

7. (canceled)

8. The process according to claim 1, wherein said microorganisms degrading said pollutants of step a) comprise heterotrophic microorganisms.

9. The process according to claim 1, wherein said microorganisms transforming the ammonium of step a) comprise nitrifying microorganisms.

10. The process according to claim 1, wherein said biofiltration at step a) is performed on a percolation biofilter on a fixed biofilm organic support.

11. The process according to claim 10, wherein said organic support comprises peat.

12. The process according to claim 10, wherein said organic support comprises at least one woodchip zone.

13. The process according to claim 10, wherein said organic support also comprises an inorganic compound.

14. The process according to claim 13, wherein said inorganic compound comprises calcium carbonate.

15. The process according to claim 15, wherein said calcium carbonate comes from oyster shells or calcite.

16. The process according to claim 12, wherein said woodchip zone is inoculated with said methanotrophic microorganisms.

17. The process according to claim 16, wherein said methanotrophic microorganisms are methanotrophic bacteria.

18. A system for the simultaneous treatment of a gas containing methane, and a liquid effluent containing ammonium or nitrates and other toxic pollutants, said system comprising:
a) a percolation biofilter on a fixed biofilm organic support adapted to carry out a biofiltration of said effluent, said organic support being adapted to support the growth of microorganisms adapted to convert ammonium into nitrates and to degrade other pollutants; said organic support also being adapted to support the growth of methanotrophic microorganisms adapted to convert the methane into biomass and CO₂ via an exothermic reaction;
b) a ventilation device adapted to introduce said gas at the bottom of said organic support and to push it upwards through said organic support in an aerobic condition;
c) a capture device located at the bottom of said biofilter to recover and evacuate the treated effluent; and
d) the surface of said organic support being adapted to discharge said treated gas into the atmosphere;
wherein said nitrates contained in the effluent or produced from the ammonium serve as nutrients for the growth of methanotrophic microorganisms;
said exothermic reaction thus producing an amount of heat to keep the temperature of at least one portion of the organic support within an operational range for the conversion of methane and the degradation of pollutants.

19. The system according to claim 18 also comprising e) a pumping device to adjust the flow rate of said effluent in order to control the temperature of the organic support.

20.-32. (canceled)

33. The process according to claim 1, wherein the liquid effluent is a landfill leachate.

34. (canceled)

35. The process according to claim 1, wherein the gas containing methane is a landfill gas.

36. (canceled)
